(19) United States
(12) Patent Application Publication
(10) Pub. No.: US 2009/0178966 A1
(43) Pub. Date: Jul. 16, 2009

(54) Process for Producing Organic Porous Material and Organic Porous Column and Organic Porous Material

(75) Inventors: Kazuki Nakanishi, Kyoto (JP); Kazuyoshi Kanamori, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: KYOTO UNIVERSITY, Kyoto-shi (JP)

(21) Appl. No.: 12/083,208

(22) PCT Filed: Oct. 6, 2006
(86) PCT No.: PCT/JP2006/320134

§ 371 Date: Apr. 7, 2008

(30) Foreign Application Priority Data
Oct. 7, 2005 (JP) 2005-294788

(51) Int. Cl. B01D 15/08; C08J 9/00

(52) U.S. Cl. 210/198.2; 521/149

(57) ABSTRACT

An organic porous material is provided being excellent in mechanical properties such as strength and in which structures of a skeleton and pores are controlled more precisely. By a production process including (i) subjecting a low molecular compound having living radical and/or anionic polymerizability to living radical or anionic polymerization in a system including the compound, an organic polymer as a phase separation inducing component, a polymerization initiator, and a polymerization solvent, and thereby forming a gel including a skeletal phase rich in a polymer of the compound and a solvent phase rich in the solvent and having a co-continuous structure formed of the skeletal and solvent phases, and (ii) removing the solvent from the gel thus formed to form a skeleton containing the polymer as a base material thereof from the skeletal phase while forming first pores from the solvent phase, and thereby obtaining an organic porous material with a co-continuous structure formed of the skeleton and the first pores.

### TECHNICAL FIELD

The present invention relates to a process for producing organic porous material in which a co-continuous structure of a skeleton and pores is formed, an organic porous material, and an organic porous column including an organic porous material formed by the aforementioned production process.

### BACKGROUND ART

Organic porous materials have attracted attention as porous materials that are used for separation media for liquid chromatography (LC) as well as for molecular adsorption, catalyst support, etc. Conventionally widely known materials that compose organic porous materials include polymers of vinyl monomers or copolymers of vinyl monomers and bifunctional monomers that have various functions. For example, housings such as column tubes are filled with those particulate polymers and thereby particle-filled LC columns can be obtained.

With respect to the LC columns, both an improvement in separation ability and a reduction in analysis time have been desired for a long time. With respect to the particle-filled LC columns, in order to improve the separation ability thereof, the diameter of the particles with which columns are filled has been reduced. However, since the reduction in diameter of the particles increases the pressure of a liquid for feeding a mobile phase that is required to obtain a desired flow rate (i.e. increases pressure loss of a column), there is no choice but a reduction in either the flow rate of the mobile phase or the column length. Accordingly, it is difficult to achieve both the improvement in separation ability and the reduction in analysis time. The use of particles also has been tried, with the particles having not only a reduced diameter but also an increased surface area. However, such particles have lower mechanical strength and it is difficult to fill a housing uniformly with such particles.

Accordingly, in order to improve the separation ability without increasing the pressure loss of the column, a separation medium is desired that allows a flow rate of a mobile phase to be obtained at a low liquid feeding pressure and that has a skeleton and a flow path having sizes that allow them to serve as a separation medium instead of the particles.

Recently, a column called a monolithic type column (or simply “monolithic column”) is attracting attention as an LC column having such a separation medium, and a porous material with a skeleton containing silica or an organic polymer as a base material thereof is being developed as a separation medium that actually allows a monolithic column to be formed. It is expected that the monolithic column makes it possible to achieve both the improvement in separation ability and the reduction in analysis time by controlling the sizes of the flow path and skeleton of the porous material that serves as a separation medium.

The porous material (organic porous material) with a skeleton containing an organic polymer as a base material thereof has been developed since the 1990s. For instance, JP 7 (1995)-501140 A (Document 1) discloses porous materials containing, as skeletons, polymers of vinyl monomers such as divinylbenzene or methacrylate derivatives.

Conventional organic porous materials for monolithic columns, including the porous materials disclosed in Document 1, are formed by common free-radical polymerization using a low-molecular organic solvent as a diluent, and fine particles generated through the nucleation-growth process are aggregated and joined to one another to form the skeleton thereof. These porous materials have problems in mechanical properties such as strength, because the fine particles are joined to one another by substantial point contact.

Furthermore, in the free-radical polymerization, the porosity and the average pore diameter of the resultant porous material (which correspond to the size of the flow path of the porous material) as well-as the skeleton diameter of the resultant porous material (which corresponds to the size of the skeleton of the porous material) can be changed by changing the amount of the diluent used in the polymerization system. However, since the skeleton fundamentally is formed based on the stochastic aggregation and junction of fine particles (that is, the degrees of aggregation and junction vary from region to region), it is difficult to control each of them independently. It therefore is difficult to design and produce porous materials that are suited for various applications as separation media or applications other than the separation media.

### DISCLOSURE OF INVENTION

A process for producing an organic porous material of the present invention includes (i) subjecting a low molecular compound having living radical polymerizability and/or anionic polymerizability to living radical polymerization or anionic polymerization in a system (polymerization system) including the low molecular compound, an organic polymer to be used as a phase separation inducing component, a polymerization initiator, and a polymerization solvent, and thereby forming a gel that includes a skeletal phase rich in a polymer of the low molecular compound and a solvent phase rich in the polymerization solvent and that has a co-continuous structure formed of the skeletal phase and the solvent phase, and (ii) removing the polymerization solvent from the gel thus formed to form a skeleton containing the polymer as a base material thereof from the skeletal phase while forming a first pore from the solvent phase, and thereby obtaining an organic porous material with a co-continuous structure formed of the skeleton and the first pore.

The organic porous column of the present invention includes a housing and an organic porous material obtained by the production process of the present invention described above, with the organic porous material being contained in the housing.

An organic porous material of the present invention is a porous material with a co-continuous structure formed of a skeleton and a first pore. The porous material is obtained by: subjecting a low molecular compound having living radical polymerizability and/or anionic polymerizability to living radical polymerization or anionic polymerization in a system including the low molecular compound, an organic polymer to be used as a phase separation inducing component, a polymerization initiator, and a polymerization solvent and thereby forming a gel that includes a skeletal phase rich in a polymer of the low molecular compound and a solvent phase rich in the polymerization solvent and that has a co-continuous structure formed of the skeletal phase and the solvent phase; and removing the polymerization solvent from the gel thus formed and thereby forming a skeleton containing the polymer as a base material thereof, from the skeletal phase while forming a first pore from the solvent phase.

According to the present invention, after a gel with a co-continuous structure of a skeletal phase and a solvent phase is formed by living radical polymerization or anionic polymerization of a low molecular compound in the presence of an organic polymer to be used as a phase separation inducing component, an organic porous material can be obtained that has a co-continuous structure formed of a skeleton and pores (first pores).

### BRIEF DESCRIPTION OF DRAWINGS

FIG. 1 shows the section of Sample 1A produced in Example 1.

FIG. 2 shows the section of Sample 1B produced in Example 1.

FIG. 3 shows the section of Sample 1C produced in Example 1.

FIG. 4 shows the section of Sample 2A produced in Example 2.

FIG. 5 shows the section of Sample 2B produced in Example 2.

FIG. 6 shows the section of Sample 2C produced in Example 2.

FIG. 7 shows the section of Sample 3 produced in Example 3.

FIG. 8 shows the section of Sample 4 produced in Example 4.

FIG. 9 shows the section of Sample 5 produced in Example 5.

FIG. 10A shows the result of measurement of fine pore distribution carried out by a mercury intrusion method with respect to Sample 6 produced in Example 6.

FIG. 10B shows the result of measurement of fine pore distribution carried out by a nitrogen adsorption method with respect to Sample 6 described above.

FIG. 11A shows the result of measurement of fine pore distribution carried out by the mercury intrusion method with respect to Sample 7 produced in Example 6.

FIG. 11B shows the result of measurement of fine pore distribution carried out by the nitrogen adsorption method with respect to Sample 7 described above.

FIG. 12 shows a conventional organic porous material produced in Comparative Example 1.

FIG. 13 shows a conventional organic porous material produced in Comparative Example 2.

FIG. 14A shows the chromatogram obtained with a LC column including Sample 7 as a separation medium, which was measured in Example 7.

FIG. 14B shows the chromatogram obtained with a commercial column.

FIG. 15 shows the sections of Samples 8A to 8J produced in Example 8.

FIG. 16 shows the sections of Samples 8K to 8S produced in Example 8.

FIG. 17 shows the sections of Samples 9A to 9G produced in Example 9.

FIG. 18 shows the sections of Samples 9H to 9O produced in Example 9.

FIG. 19 shows the sections of Samples 11A to 11F produced in Example 11.

FIG. 20 shows the surface of Sample 8E produced in Example 8.

FIG. 21 shows the surface of Sample 8E shown in FIG. 20 that has been heat-treated.

FIG. 22A shows the results of measurement of fine pore distribution carried out by the mercury intrusion method with respect to Samples 13A to 13D produced in Example 13.

FIG. 22B shows the results of measurement of fine pore distribution carried out by the mercury intrusion method with respect to Samples 13C, 13F, and 13H produced in Example 13.

FIG. 23 shows the results of the binding strength test carried out with respect to Sample 13C produced in Example 13 and Sample 13C+obtained by heat-treating Sample 13C.

### DESCRIPTION OF THE PREFERRED EMBODIMENTS

A gel having a co-continuous structure of a skeletal phase and a solvent phase is formed with an organic polymer to be used as a phase separation inducing component that induces the phase separation (typically, phase separation of a spinodal decomposition type) into a dense phase rich in a polymer of a low molecular compound (in this phase the concentration of the polymer is relatively high) and a dilute phase rich in a polymerization solvent (in this phase the concentration of the polymer being relatively low.) The skeletal phase and the solvent phase each have a continuous three-dimensional network structure and they are entangled with each other.

In this case, it is important that the polymer of a low molecular compound is formed by living radical polymerization or anionic polymerization. For example, in the case of free-radical polymerization, which is a process for producing a conventional organic porous material, after a plurality of polymer particles are formed in the polymerization system through a nucleation-growth process, these particles are aggregated stochastically and then are precipitated to form a porous structure, and therefore a gel having a co-continuous structure cannot be formed.

The skeleton and the first pores of the porous material formed, after the aforementioned gel was first obtained, by the production process of the present invention (hereinafter also referred to simply as a “porous material of the present invention”) have a continuous three-dimensional network structure corresponding to the structure of the skeletal phase and solvent phase of the gel, respectively, and are entangled with each other. The porous material of the present invention has a skeleton with a more uniform structure and better mechanical properties including, for example, strength, as compared to a conventional porous material formed through stochastic aggregation and junction of a plurality of polymer particles.

In living radical polymerization and anionic polymerization, the molecular weight and the molecular weight distribution of the resultant polymer can be controlled by controlling the polymerization system. For example, a polymer with a narrow molecular weight distribution can be formed. Furthermore, the timing of the phase separation with respect to the polymerization degree of the polymer also can be controlled by controlling the polymerization system.

According to the production process of the present invention, thus, the skeleton size and the pore size (first pore size) can be controlled independently. Therefore, for example, a porous material having a specific skeleton size and/or pore size can be formed or a porous material having a narrow distribution of skeleton size and/or pore size can be formed. That is, according to the production process of the present invention, a porous material can be formed in which the structures of the skeleton and pores are controlled more precisely as compared to the conventional porous material.

The skeleton size of the porous material of the present invention can be evaluated by, for example, the average skeleton diameter of the skeleton (with the skeleton diameter denoting the diameter of the section perpendicular to the extension direction of the skeleton). The average skeleton diameter can be determined by, for example, observing the porous material with a microscope. More specifically, it may be determined by, for example, observing the section of the porous material with a microscope such as an electron microscope or a laser confocal microscope, and then processing the image thus obtained. In the case of microscope observation, it is preferable that the section is made smooth by, for example, being polished.

The pore size of the porous material of the present invention can be evaluated by, for example, the average pore diameter of pores. The average pore diameter may be determined from the pore diameter distribution. The pore diameter distribution can be measured by fine pore distribution measurement (a mercury intrusion method or a nitrogen adsorption method) carried out with respect to the porous material. The mercury intrusion method and the nitrogen adsorption method may be carried out according to general procedures.

The expression “controlling the polymerization system” denotes, for example, changing the polymerization temperature or polymerization time or changing the type and ratio of the low molecular compound, organic polymer, polymerization initiator, and/or polymerization solvent to be used.

The porous material of the present invention can be used as a separation medium for an LC column. In this case, the first pores are macropores that serve as a flow path for the mobile phase. That is, the production process of the present invention makes it possible to obtain a separation medium having a predetermined macropore diameter and/or a separation medium with a narrow macropore diameter distribution. The LC column including the porous material of the present invention to be used as a separation medium can be considered as one type of monolithic column. The term “macropore” used in this specification denotes a term “macropore” that is used generally in the field of the LC column.

The size of the first pores of the porous material of the present invention is not particularly limited. The average pore diameter thereof is generally in the range exceeding approximately 100 nm but not exceeding approximately 100 μm. In this range, a porous material having a co-continuous structure is formed based on the induction of phase separation. When the porous material of the present invention is used as a separation medium for an LC column, the average pore diameter of the first pores (i.e. macropores) is preferably in the range of approximately 500 nm to 5 μm and more preferably in the range of approximately 800 nm to 3 μm, from the viewpoints of achieving both an improvement in separation ability and a reduction in pressure loss in the separation medium.

The size of the skeleton of the porous material according to the present invention is not particularly limited. However, since a porous material having a co-continuous structure is formed based on the induction of phase separation, generally, the average skeleton diameter is in the range of approximately 100 nm to 50 μm.

The living radical polymerization and the anionic polymerization may be carried out by general methods that are employed for the respective polymerization methods. For example, an organic polymer to be used as a phase separation inducing component is dissolved in a polymerization solvent and thereby a solution is formed. Thereafter, the solution thus formed, a low molecular compound, and a polymerization initiator are mixed together to form a polymerization system. Then in the polymerization system thus formed, the low molecular compound is polymerized. In practical polymerization, the type and amount of the polymerization initiator and the polymerization solvent may be selected or the polymerization temperature and the polymerization time may be controlled as required.

The low molecular compound is not particularly limited, as long as it has living radical polymerizability and/or anionic polymerizability. A compound having at least one selected from a vinyl group and an allyl group is preferable since it has high living radical polymerizability and/or anionic polymerizability. Specific examples thereof include vinyl compounds such as various (meth)acrylic esters such as trimethylpropanetrimethacrylate (TRIM), (meth)acrylamide, styrene, and divinylbenzene.

The low molecular compound may be a monomer and may be in the state where monomers have been polymerized to a certain degree (for example, an oligomer, preferably with a molecular weight of approximately 1000 or less).

In the production process of the present invention, two types or more of low molecular compounds may be polymerized in the polymerization system. In this case, at least one type of the aforementioned two types or more of low molecular compounds may be a polyfunctional low molecular compound (polyfunctional compound) having at least two carbon-carbon multiple bonds. The polyfunctional compound having at least two carbon-carbon multiple bonds (typically, double bonds) (that is, having functionality of at least tetrafunctionality) is a so-called “crosslinker” that forms a three-dimensional crosslinked structure during polymerization. The production process of the present invention allows the proportion of crosslinkers contained in the low molecular compound to be increased as compared to the process for producing a conventional porous material using free-radical polymerization.

For example, the carbon double bond contained in, for instance, a vinyl group or a (meth)acrylic group newly forms a covalent bond (intermolecurar bond) between molecules with a polymerization initiator and thereby allows polymerization to be carried out. In this context, the site itself of, for example, the vinyl group or (meth)acrylic group is called a functional group. Since each functional group can form two intermolecular bonds, it has bifunctionality. That is, the functionality of the low molecular compound can be indicated with a value obtained by multiplying the number of the functional groups of the low molecular compound by 2. For example, styrene (vinylbenzene) has bifunctionality, and divinylbenzene has tetrafunctionality.

The proportion of the polyfunctional compound in the low molecular compound may be at least 33.3 vol % or may be at least 50 vol %. The selection of the polymerization system also makes it possible to polymerize the polyfunctional compound alone. In common free-radical polymerization, the proportion of the polyfunctional compound in compounds to be polymerized is preferably 10 vol % or lower and maximally about 33.3 vol %. When the proportion of the polyfunctional compound is excessively high in the common polymerization, variations in the polymerization reaction increase (the difference between a region where the reaction proceeds and a region where the reaction does not proceed increases significantly) and the formation of the skeleton itself may become difficult.

As described above, in the production process of the present invention, a polymer containing a large amount of crosslinker can be used as a base material of the skeleton. Accordingly, a porous material can be formed that has better mechanical properties including, for example, strength as compared to the conventional porous materials.

The organic polymer to be used as a phase separation inducing component is not particularly limited as long as it can be added to the polymerization system in a uniform state, for example, with the organic polymer being soluble in a polymerization solvent. Examples of the organic polymer include polystyrene, polyethyleneglycol, polyethylene oxide, polydimethylsiloxane, polymethylmethacrylate, and copolymers thereof.

Although the reason why an addition of an organic polymer to the polymerization system induces the phase separation that forms a co-continuous structure is not clear, the following reason is conceivable. That is, as polymerization of the low molecular compound proceeds, the compatibility thereof with the organic polymer falls, and when conditions are satisfied such that, for example, the distribution of molecular weights of polymers of the low molecular compound is within a certain range (that is, the molecular weight distribution is narrow), the phase separation caused by spinodal decomposition is induced.

The amount of the organic polymer to be added to the polymerization system varies depending on the polymerization system, for example, the type of the low molecular compound. It is, for example, in the range of 1 part by weight to 100 parts by weight, preferably in the range of 5 parts by weigh to 20 parts by weight, with respect to 100 parts by weight of low molecular compound.

The polymerization solvent is not particularly limited, as long as it allows the low molecular compound and the organic polymer to be dissolved therein. Solvents that are used generally for living radical polymerization and/or anionic polymerization may be used. Specific examples thereof include toluene, xylene, trimethylbenzene, dimethylformamide (DMF), methanol, ethanol, tetrahydrofuran (THF), benzene, and water.

The polymerization initiator is not particularly limited, as long as it allows living radical polymerization or anionic polymerization of the low molecular compound. Polymerization initiators that are used generally for living radical polymerization and/or anionic polymerization may be used. Specific examples thereof include, peroxide (living radical polymerization) such as benzoyl peroxide (BPO), an azo initiator (living radical polymerization) such as azobisisobutyronitrile (AIBN), persulfate (living radical polymerization) such as ammonium persulfate, alkyl alkali (anionic polymerization) such as n-butyllithium, and alkali metal alkoxide (anionic polymerization) such as potassium-tert-butoxide. The selection of the polymerization initiator also allows living anionic polymerization of the low molecular compound. For example, the aforementioned polymerization initiators generally allow living anionic polymerization to be carried out.

A so-called iniferter may be used as the polymerization initiator (living radical polymerization). Typical examples of the iniferter include benzyl N,N-diethyldithiocarbamate (BDC).

In order to carry out living radical polymerization or anionic polymerization more stably, an additional material may be added to the polymerization system. For instance, when living radical polymerization is to be carried out, it may be necessary for the polymerization system to contain materials such as a stable radical, a transition metal complex, and a reversible chain transfer agent (RAFT agent) as well as a polymerization initiator. When the polymerization system contains a stable radical, the adjustment in the ratio between the stable radical concentration and the polymerization initiator concentration in the polymerization system allows more steady control of the mesopores, which are described later, to be achieved.

Examples of the stable radical include nitroxides such as 2,2,6,6-tetramethyl-1-piperidinyloxy (TEMPO).

In addition, the polymerization system may contain, as the aforementioned additional material, for example, a material that changes the polymerization reaction rate (for instance, acetic anhydride).

In the production process of the present invention, for example, the skeleton size, the pore size, and/or the ratio between the skeleton size and the pore size of the porous material to be obtained can be controlled through a relative increase or decrease in amounts of the low molecular compound, organic polymer, polymerization solvent, and/or polymerization initiator in the polymerization system.

The method of removing the polymerization solvent from a gel formed by phase separation is not particularly limited. For example, solvent substitution is carried out with a solvent in which polymer that serves as a base material of the skeletal phase is not dissolved, and thereafter, the whole is dried.

The production process of the present invention further may include a step of removing the organic polymer remaining in a resultant porous material. All or part of the organic polymer added to the polymerization system as a phase separation inducing component may remain in the skeleton of the porous material. Particularly, when the organic polymer moves to the skeletal phase of the gel as the phase separation proceeds, the residual volume thereof tends to increase. For example, when the resultant porous material is used as a separation medium for LC, the remaining organic polymer can degrade the separation ability of the separation medium. In such a case, therefore, the organic polymer remaining in the porous material may be removed as required.

The method of removing the organic polymer is not particularly limited. For instance, after the inner part of the porous material is filled with a solvent in which the skeleton is not dissolved but the organic polymer is dissolved, the solvent is removed. When the polymerization solvent is removed from the gel formed by phase separation, solvent substitution is carried out using the solvent, so that the polymerization solvent and the organic polymer may be removed simultaneously.

In the production process of the present invention, control of the polymerization system makes it possible to form second pores with smaller pore diameters than those of the first pores at the surface of the skeleton and further to control the pore diameter of the second pore and the distribution of the pore diameters. For example, when the low molecular compound is subjected to living radical polymerization, they can be controlled by changing the concentration ratio between the polymerization initiator and the stable radical that are contained in the polymerization system. The amount of the second pores to be formed at the surface of the skeleton tends to decrease with an increase in the ratio of the stable radical to the polymerization initiator and tends to increase with a decrease in the ratio.

When the porous material of the present invention in which the second pores have been formed is used as a separation medium for an, LC column, the second pores are mesopores. That is, the production process of the present invention makes it possible to obtain a separation medium with a predetermined mesopore diameter and/or a separation medium with a narrow mesopore diameter distribution. In this specification, the term “mesopore” denotes the term “mesopore” that is used generally in the field of LC column.

The size of the second pores of the porous material according to the present invention is not particularly limited. Generally, the average pore diameter thereof is in the range of 2 nm to 100 nm. When the porous material of the present invention in which the second pores have been formed is used as a separation medium for an LC column, although it depends on the substance to be subjected to LC measurement, the average pore diameter of the second pores (that is, mesopores) is preferably approximately 10 nm (when the substance concerned is a low molecular substance) or preferably in the range of approximately 20 nm to 30 nm (when the substance concerned is a, high molecular substance). The average pore diameter of the second pores may be determined from the pore diameter distribution. The distribution can be measured by fine pore distribution measurement (the mercury intrusion method or the nitrogen adsorption method) that is carried out with respect to the porous material.

In the production process of the present invention, after the gel is formed in step (i) or after the porous material is formed in step (ii), the shapes thereof may be changed as required. For instance, it may be shaped by machining or cutting or it may be pulverized when a porous material for a catalyst carrier is to be produced therefrom. When the porous material of the present invention is to be used for a separation medium for LC, it may be formed into a cylindrical or disk shape.

The porous material of the present invention can be used widely not only as separation media for LC (particularly, separation media for reversed-phase liquid chromatography) but also, for example, porous materials for blood separation, sample concentration media that are used for environmental analysis, porous materials for low molecular adsorption that are used for deodorization, enzyme carriers, and catalyst carriers. When it is used as a separation medium for LC, a housing such as a column tube is filled with the porous material of the present invention to form an organic porous column.

The organic porous column of the present invention includes an organic porous material obtained by the aforementioned production process of the present invention and a housing such as a column tube, with the housing being filled with the aforementioned organic porous material. As described above, in the production process of the present invention, a porous material can be formed that is excellent in mechanical properties such as strength and that has a skeleton and pores (first and second pores) whose structures are controlled more precisely. Accordingly, an organic porous column including such a porous material is easy to use in various applications and can be a column that is excellent in properties in each application.

For instance, when the organic porous column of the present invention is used for an LC column, since the column concerned includes an organic porous material in which sizes and distributions of the first pores, which are macropores, the second pores, which are mesopores, and the skeleton can be controlled independently, an organic porous column can be obtained that has a more suitable structure for a substance to be subjected to LC measurement.

Furthermore, since the organic porous column of the present invention includes a porous material having a skeleton containing an organic polymer as a base material thereof, it is stable even under a highly acidic or strongly alkaline atmosphere and thereby the solvent to be used as a mobile phase and a substance to be measured can be selected from a broad range.

### EXAMPLES

Hereinafter, the present invention is described in further detail using examples. The present invention is not limited to the following examples.

### Example 1

In Example 1, using trimethylpropanetrimethacrylate (TRIM, hexafunctional) as a low molecular compound and polystyrene (PSt) as an organic polymer that was used as a phase separation inducing component, an organic porous material was produced by anionic polymerization.

First, a solution was formed by uniformly dissolving 0.21 g of PSt (with a weight average molecular weight of 230000) used as an organic polymer, in 7 ml of toluene used as a polymerization solvent. Subsequently, 0.05 g of potassium-tert-butoxide (t-BuOK) used as a polymerization initiator and 3 ml of TRIM monomers used as a low molecular compound were added to the solution formed above, which then was stirred uniformly. Thereafter, the whole was sealed, the temperature thereof was increased to 40° C., and it was subjected to polymerization for about 10 minutes. As a result, a wet gel containing the polymerization solvent was formed.

Next, the gel thus formed was subjected to solvent substitution using tetrahydrofuran (THF). Thereafter, the whole was dried at 40° C. and thereby the polymerization solvent was removed. Thus, an organic porous material (Sample 1A) was produced.

The structure of Sample 1A thus produced was evaluated with a scanning electron microscope (SEM). As a result, it was observed that first pores and a skeleton containing a polymer of TRIM as a base material thereof were formed, and the skeleton and the first pores formed a co-continuous structure. Furthermore, from this evaluation result, it is conceivable that a gel having a co-continuous structure of a skeletal phase and a solvent phase was formed by the above-mentioned anionic polymerization.

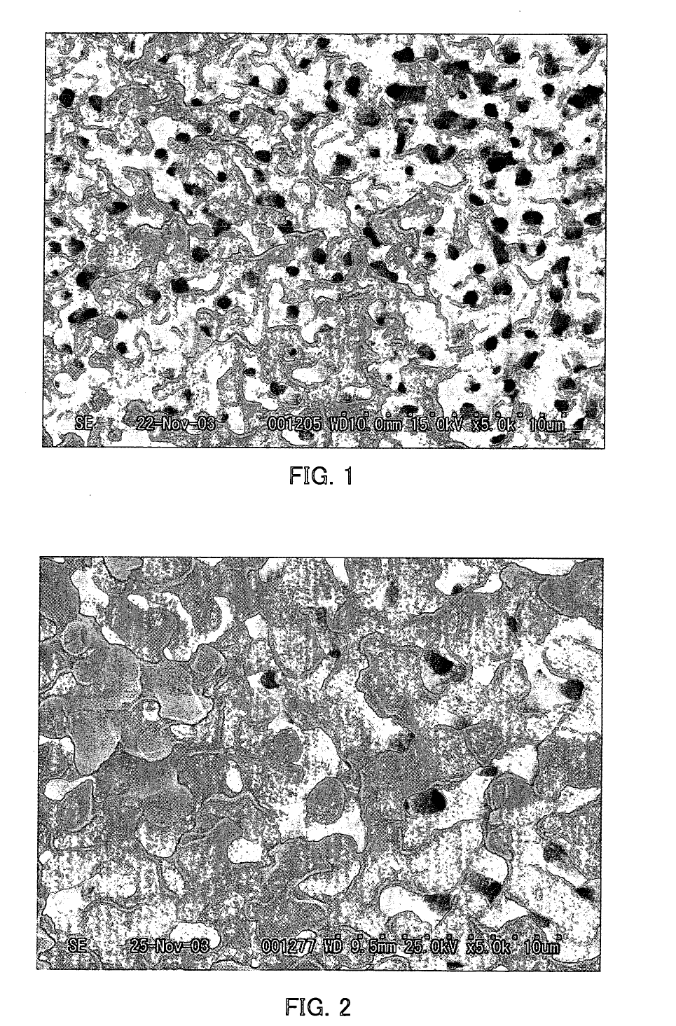

FIG. 1 shows the section of Sample 1A measured with a SEM. With respect to the samples described below, the structures of the resultant porous materials were evaluated in the same manner.

Sample 1A was subjected to a fine pore distribution measurement by the mercury intrusion method and the nitrogen adsorption method. As a result, peaks of the differentiation of fine pore volume with respect to the fine pore diameter (diameter of the pore) were observed in the vicinity of about 1 μm (first peak) and in the vicinity of about 80 nm (second peak) in terms of the fine pore diameter. The first peak and the second peak correspond to the first pores and the second pores, respectively. Accordingly, the average pore diameters of the first and second pores can be considered to be about 1 μm and about 80 nm, respectively.

Next, an organic porous material (Sample 1B) was produced in the same manner as in the case of Sample 1A except that the amount of PSt used as the organic polymer was 0.27 g. Thereafter, the structure of Sample 1B thus produced was evaluated. As a result, it was observed that first pores and a skeleton containing a polymer of TRIM as a base material thereof were formed and the skeleton and the first pores formed a co-continuous structure. FIG. 2 shows the section of Sample 1B measured with the SEM.

As shown in FIG. 2, it was possible to increase the sizes of the skeleton and the first pores of the resultant porous material by increasing the relative amount of the phase separation inducing component (PSt) contained in the anionic polymerization system.

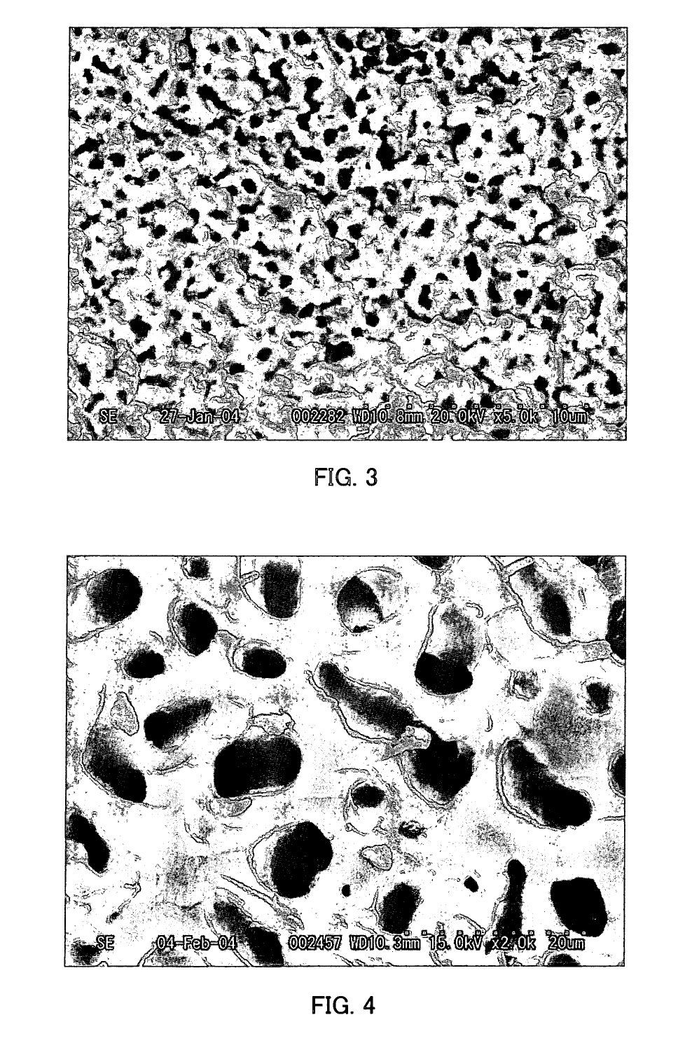

Subsequently, an organic porous material (Sample 1C) was produced in the same manner as in the case of Sample 1A except that the amount of toluene used as the polymerization solvent was 8 ml. Thereafter, the structure of Sample 1C thus produced was evaluated. As a result, it was observed that first pores and a skeleton containing a polymer of TRIM as a base material thereof were formed and the skeleton and the first pores formed a co-continuous structure. FIG. 3 shows the section of Sample 1C measured with the SEM.

As shown in FIG. 3, by increasing the relative amount of the polymerization solvent (toluene) contained in the anionic polymerization system, it was possible to reduce the size of the skeleton and to increase the size of the first pores of the resultant porous material, that is, it was possible to increase the fine pore volume and porosity of the resultant porous material.

### Example 2

In Example 2, using divinylbenzene (DVB, tetrafunctional) as a low molecular compound and a polystyrene-polymethylmethacrylate copolymer (PSt-co-PMMA) as an organic polymer to be employed as a phase separation inducing component, an organic porous material was formed by living radical polymerization.

First, a solution was formed by uniformly dissolving 0.21 g of PSt-co-PMMA (with a molecular weight of 100000 to 150000 and 40% of styrene structural units) used as an organic polymer, in 4 ml of toluene used as a polymerization solvent. Subsequently, 0.01 g of benzoyl peroxide (BPO) used as a polymerization initiator, 0.01 g of 2,2,6,6-tetramethyl-1-piperidiniloxy (TEMPO) used as a stable radical, and 4 ml of DVB monomers used as a low molecular compound were added to the solution formed above, which then was stirred uniformly. Thereafter, degassing was carried out by ultrasonic irradiation for five minutes. Furthermore, nitrogen substitution was carried out for ten minutes. Subsequently, the whole was sealed, and it was subjected to polymerization for about 90 minutes at a temperature increased to 95° C. and then for 48 hours at a temperature increased to 125° C. As a result, a wet gel containing the polymerization solvent was formed.

Next, the gel thus formed was subjected to solvent substitution using tetrahydrofuran (THF). Thereafter, the whole was dried at 40° C. and thereby the polymerization solvent was removed. Thus, an organic porous material (Sample 2A) was produced.

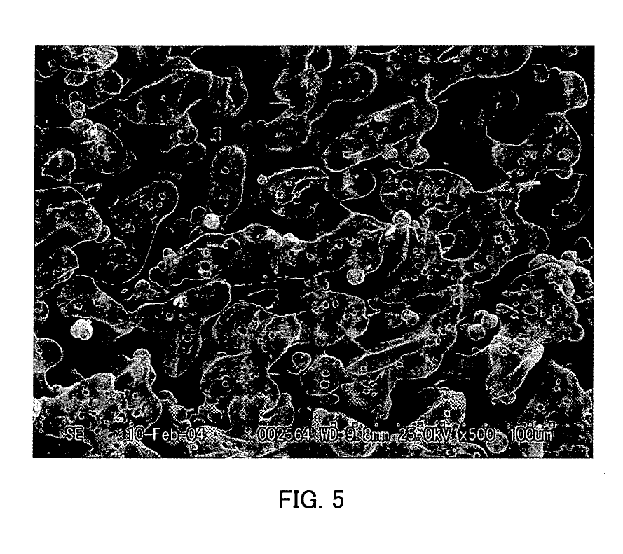

The structure of Sample 2A thus produced was evaluated with the SEM. As a result, it was observed that first pores and a skeleton containing a polymer of DVB as a base material thereof were formed and the skeleton and the first pores formed a co-continuous structure. Furthermore, from this evaluation result, it is conceivable that a gel having a co-continuous structure of a skeletal phase and a solvent phase was formed by the above-mentioned living radical polymerization. FIG. 5 shows the section of Sample 2A measured with the SEM. The minute pores observed in the skeleton shown in FIG. 5 are those formed by further phase separation (secondary phase separation) that occurs in the skeleton. They often are formed when the phase separation has proceeded further, that is, when the skeleton diameter and the size of the first pores have increased considerably. They are different from the second pores (mesopores) described above.

Next, an organic porous material (Sample 2B) was produced in the same manner as in the case of Sample 2A except that the amount of PSt-co-PMMA used as the organic polymer was 0.25 g. Thereafter, the structure of Sample 2B thus produced was evaluated. As a result, it was observed that first pores and a skeleton containing a polymer of DVB as a base material thereof were formed and the skeleton and the first pores formed a co-continuous structure. FIG. 5 shows the section of Sample 2B measured with the SEM.

As shown in FIG. 5, it was possible to increase the sizes of the skeleton and the first pores of the resultant porous material by increasing the relative amount of the phase separation inducing component (PSt-co-PMMA) contained in the living radical polymerization system.

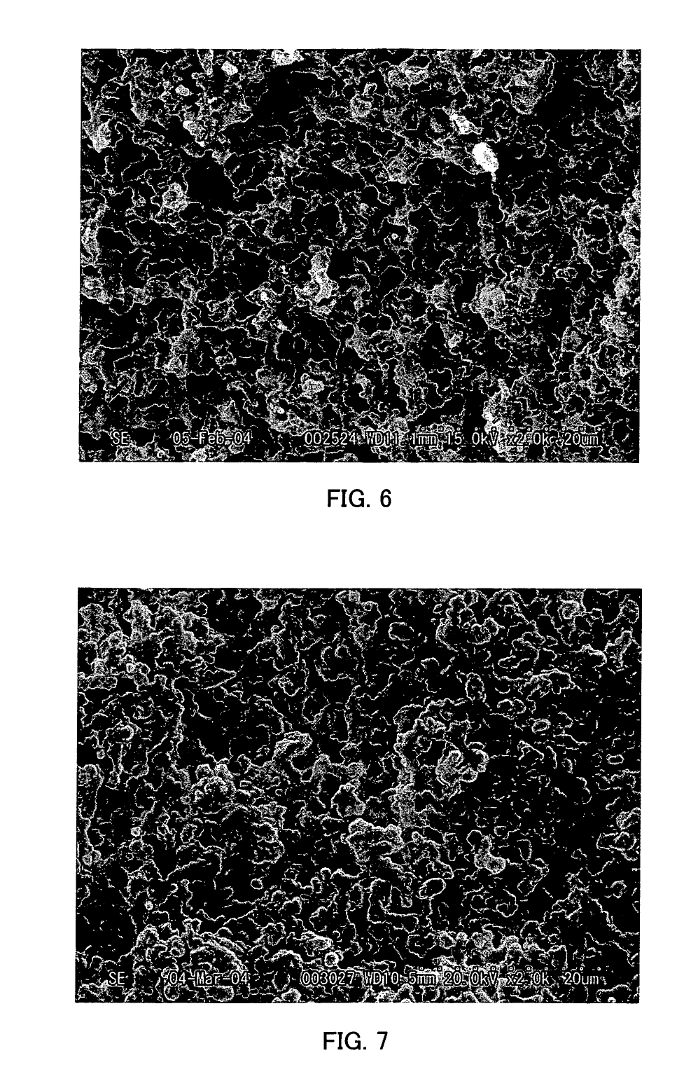

Subsequently, an organic porous material (Sample 2C) was produced in the same manner as in the case of Sample 2A except that the amount of toluene used as the polymerization solvent was 5 ml. Thereafter, the structure of Sample 2C thus produced was evaluated. As a result, it was observed that first pores and a skeleton containing a polymer of DVB as a base material thereof were formed and the skeleton and the first pores formed a co-continuous structure. FIG. 6 shows the section of Sample 2C measured with the SEM.

As shown in FIG. 6, by increasing the relative amount of the polymerization solvent (toluene) contained in the living radical polymerization system, it was possible to reduce the size of the skeleton and to increase the size of the first pores of the resultant porous material, that is, it was possible to increase the fine pore volume and porosity of the resultant porous material.

### Example 3

A wet gel containing a polymerization solvent was formed in the same manner as in Example 2 using 4 ml of mixed monomers (St:DVB=1:2 (volume ratio)) of styrene (St, bifunctional) and DVB as a low molecular compound, 3 ml of dimethylformamide (DMF) as a polymerization solvent, 0.18 g of PSt-co-PMMA as an organic polymer, which was used in Example 2, 0.01 g of BPO as a polymerization initiator, and 0.01 g of TEMPO as a stable radical.

Next, the gel thus formed was subjected to solvent substitution using tetrahydrofuran (THF). Thereafter, the whole was dried at 40° C. and thereby the polymerization solvent was removed. Thus, an organic porous material (Sample 3) was produced.

The structure of Sample 3 thus produced was evaluated with the SEM. As a result, it was observed that first pores and a skeleton containing a polymer of St and DVB as a base material thereof were formed and the skeleton and the first pores formed a co-continuous structure. FIG. 7 shows the section of Sample 3 measured with the SEM.

### Example 4

A wet gel containing a polymerization solvent was formed in the same manner as in Example 2 using 4 ml of DVB monomers as a low molecular compound, 3.5 ml of toluene as a polymerization solvent, 0.36 g of polydimethylsiloxane (DMS with a weight average molecular weight of 13,650) as an organic polymer, 0.01 g of BPO as a polymerization initiator, and 0.01 g of TEMPO as a stable radical.

Next, the gel thus formed was subjected to solvent substitution using tetrahydrofuran (THF). Thereafter, the whole was dried at 40° C. and thereby the polymerization solvent was removed. Thus, an organic porous material (Sample 4) was produced.

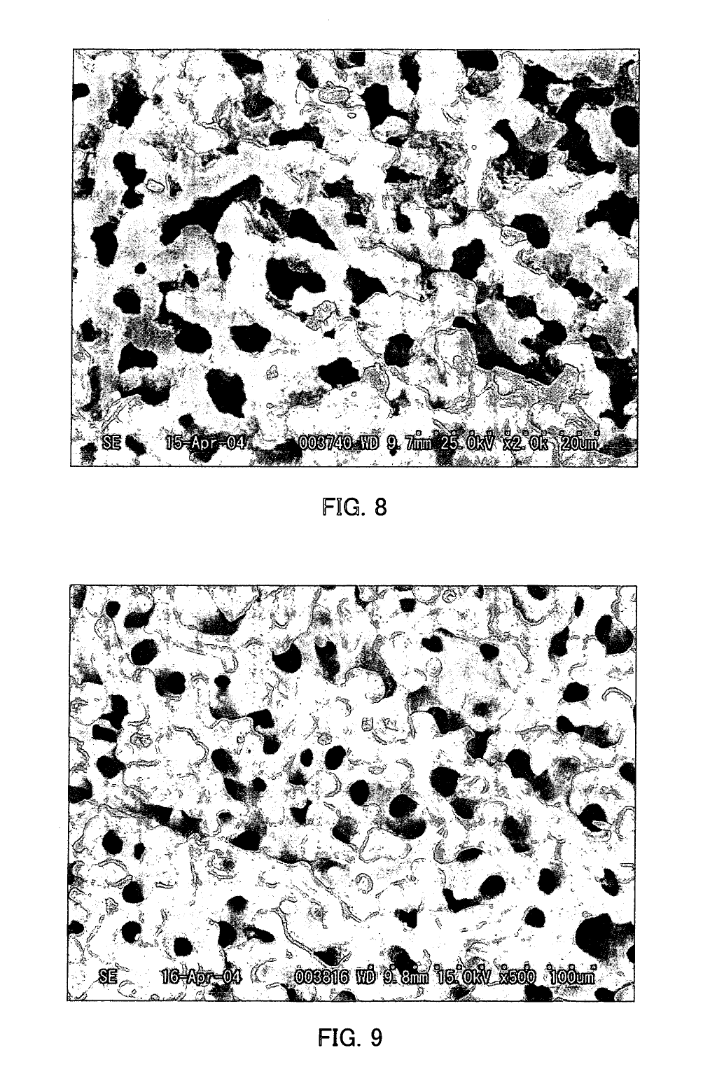

The structure of Sample 4 thus produced was evaluated with the SEM. As a result, it was observed that first pores and a skeleton containing a polymer of DVB as a base material thereof were formed and the skeleton and the first pores formed a co-continuous structure. FIG. 8 shows the section of Sample 4 measured with the SEM.

Sample 4A was subjected to fine pore distribution measurement by the mercury intrusion method and the nitrogen adsorption method. As a result, peaks of the differential of fine pore volume with respect to the fine pore diameter were observed in the vicinity of about 3 μm (first peak) and in the vicinity of about 3 nm (second peak) in terms of fine pore diameter. The first peak and the second peak correspond to the first pores and the second pores, respectively.

### Example 5

A wet gel containing a polymerization solvent was formed in the same manner as in Example 2 using 4 ml of mixed monomers (St:DVB=1:1 (volume ratio)) of St and DVB as a low molecular compound, 3.5 ml of toluene as a polymerization solvent, 0.37 g of DMS as an organic polymer, which was used in Example 4, 0.01 g of BPO as a polymerization initiator, and 0.01 g of TEMPO as a stable radical.

Next, the gel thus formed was subjected to solvent substitution using tetrahydrofuran (THF). Thereafter, the whole was dried at 40° C. and thereby the polymerization solvent was removed. Thus, an organic porous material (Sample 5) was produced.

The structure of Sample 5 thus produced was evaluated with the SEM. As a result, it was observed that first pores and a skeleton containing a copolymer of St and DVB as a base material thereof were formed and the skeleton and the first pores formed a co-continuous structure. FIG. 9 shows the section of Sample 5 measured with the SEM.

### Example 6

First, a solution was formed by uniformly dissolving 1.15 g of DMS used as an organic polymer, which was employed in Example 4, in 14 ml of trimethylbenzene (TMB) used as a polymerization solvent. Subsequently, 0.1 g of BPO used as a polymerization initiator, 0.1 g of TEMPO used as a stable radical, 10 ml of DVB monomers used as a low molecular compound, and 0.05 ml of acetic anhydride (Ac₂O) used as the aforementioned additional material were added to the solution formed above, which was then stirred uniformly. Thereafter, degassing was carried out by ultrasonic irradiation for five minutes. Furthermore, nitrogen substitution was carried out for ten minutes. Subsequently, the whole was sealed, and it was subjected to polymerization for about 90 minutes at a temperature increased to 95° C. and then for 48 hours at a temperature increased to 125° C. As a result, a wet gel containing the polymerization solvent was formed.

Next, the gel thus formed was subjected to solvent substitution using tetrahydrofuran (THF). Thereafter, the whole was dried at 40° C. and thereby the polymerization solvent was removed. Thus, an organic porous material (Sample 6) was produced.

The structure of Sample 6 thus produced was evaluated with the SEM. As a result, it was observed that first pores and a skeleton containing a polymer of DVB as a base material thereof were formed and the skeleton and the first pores formed a co-continuous structure.

Separately from the production of Sample 6, a gel swollen with a polymerization solvent was formed in the same manner as in the case of Sample 6 except that the amount of BPO used as a polymerization initiator was 0.025 g.

Next, the gel thus formed was subjected to solvent substitution using tetrahydrofuran (THF). Thereafter, the whole was dried at 40° C. and thereby the polymerization solvent was removed. Thus, an organic porous material (Sample 7) was produced.

The structure of Sample 7 thus produced was evaluated with the SEM. As a result, it was observed that first pores and a skeleton containing a polymer of DVB as a base material thereof were formed and the skeleton and the first pores formed a co-continuous structure.

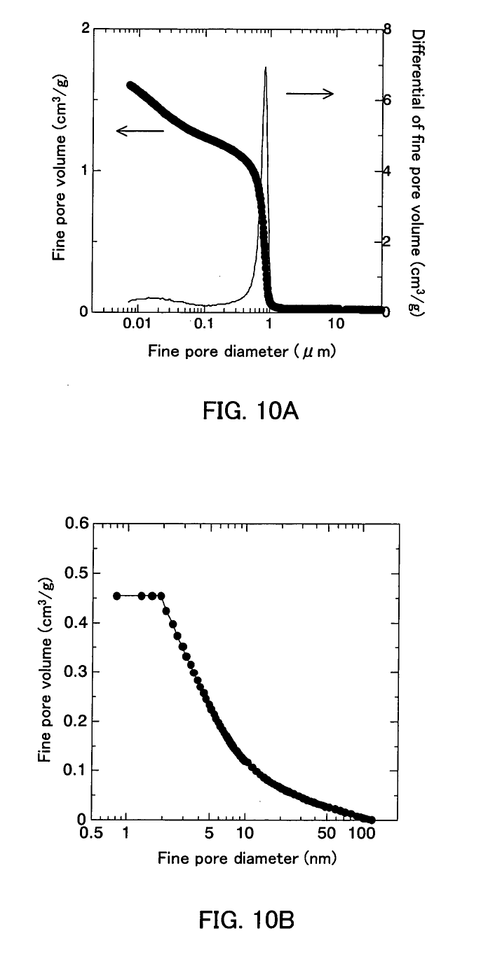

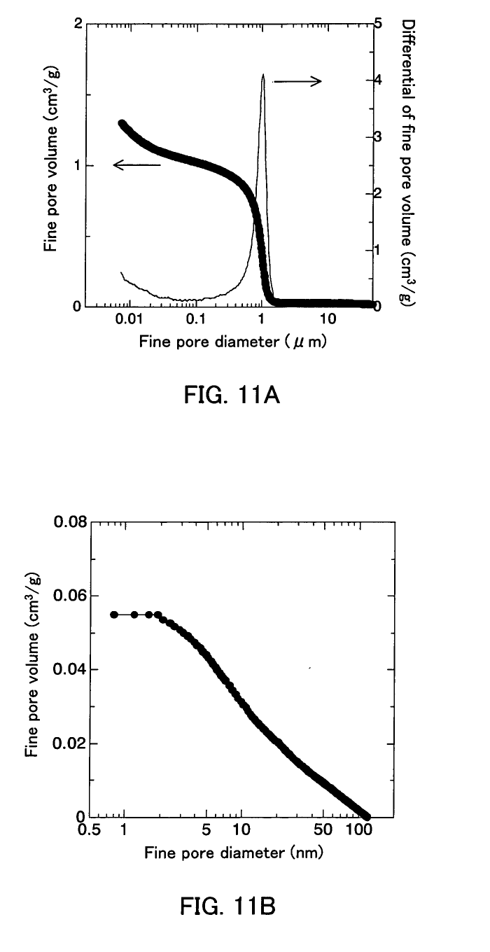

Samples 6 and 7 were subjected to fine pore distribution measurement by the mercury intrusion method and the nitrogen adsorption method and thereby the results shown in FIG. 10 (Sample 6) and FIG. 11 (Sample 7) were obtained. FIGS. 10A and 11A show the results of measurements carried out by the mercury intrusion method, and FIGS. 10B and 11B show the results of measurements carried out by the nitrogen adsorption method.

The measurement carried out by the mercury intrusion method was performed according to a common method, and then conversion thereof into the fine pore diameter was carried out using the Washburn formula. The measurement apparatus used herein was PORESIZER 9310 manufactured by Micromeritics Instrument Corporation. The measurement carried out by the nitrogen adsorption method was performed according to a common method, and the adsorption isotherm data obtained thereby was converted into a fine pore diameter based on the BJH (Brrett-Joyner-Halenda) theory. The measurement apparatus used herein was ASAP 2010 manufactured by Micromeritics Instrument Corporation. The same applies to the fine pore distribution measurement in other examples.

As shown in FIGS. 10A and 11A, a peak (a first peak) of the differentiation of fine pore volume with respect to the fine pore diameter was observed in the vicinity of about 1 μm in terms of the fine pore diameter in both Samples 6 and 7. The first peak corresponds to the first pores of the porous material. In Sample 6, a peak of the differential described above also was observed in the vicinity of approximately 10 nm to 20 nm in terms of the fine pore diameter (second peak), while in Sample 7, such a peak corresponding to the second pores was not observed, and the differential value increased with a decrease in fine pore diameter.

According to the results of measurements carried out by the nitrogen adsorption method as shown in FIGS. 10B and 11B, the accumulated fine pore volume within the range of 1.7 nm to 300 nm of the fine pore diameter was 0.48 cm³/g and the BET specific surface area was 621.9 m²/g in Sample 6, while the accumulated fine pore volume within the same range as above of the fine pore diameter was 0.07 cm³/g and the BET specific surface area was 33.6 m²/g in Sample 7. Conceivably, the second pores formed in Sample 6 hardly were formed in Sample 7. Presumably, the reason why an increment of the fine pore volume in the range where the pore diameter was 100 nm or smaller increased in FIG. 11A is because mercury was injected at a high pressure and thereby a part of the structure of the skeleton was broken.

### Comparative Example 1

In Comparative Example 1, an organic porous material was formed using conventional free-radical polymerization.

First, mixed monomers of ethylene glycol dimethacrylate (EGDMA) and octadecyl methacrylate (ODMA) (EGDMA:ODMA=1:2 (molar ratio)) and a mixture of 1,4-butanediol and 1-propanol (30:70 by weight ratio) were mixed together in such a manner that the weight ratio of the mixed monomers and the mixture was 40:60, and thereby a uniform solution was formed. Subsequently, 2-acrylamide-2-methyl-1-propylsulfonic acid and 2,2′-azobisisobutyronitrile whose amount was 0.3 wt % of the mixed monomers further was mixed as a polymerization initiator into the solution formed above. This was subjected to degassing and nitrogen substitution in the same manner as in Example 2. Thereafter the whole was sealed and then was subjected to polymerization at 60° C. for 20 hours.

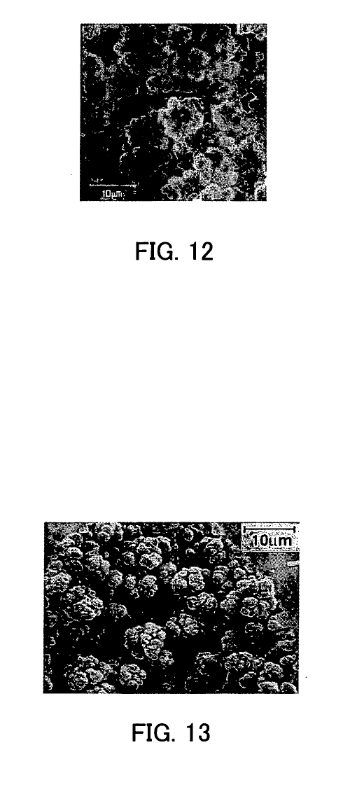

The structure of the formed product obtained through the reaction was evaluated with the SEM. As a result, it had a structure in which spherical particles had been aggregated as shown in FIG. 12.

### Comparative Example 2

In Comparative Example 2, an organic porous material was formed using conventional free-radical polymerization.

First, mixed monomers of St and DVB (St:DVB=2:1 (volume ratio)) and n-propanol were mixed together in such a manner that the weight ratio of the mixed monomers and n-propanol was 40:60, and thereby a uniform solution was formed. Subsequently, 2,2′-azobisisobutyronitrile whose amount was 0.1 wt % of the mixed monomers further was mixed as a polymerization initiator into the solution formed above. This was subjected to degassing and nitrogen substitution in the same manner as in Example 2. Thereafter, the whole was sealed and then was subjected to polymerization at 70° C. for 20 hours.

The structure of the formed product obtained through the reaction was evaluated with the SEM. As a result, it had a structure in which spherical particles had been aggregated as shown in FIG. 13.

### Example 7

### Application to Liquid Chromatography

First, an organic porous material was produced in the same manner as in Example 4. The organic porous material was produced as follows. That is, a gel was formed in a cylindrical glass tube by living radical polymerization and then was subjected to solvent substitution to form a porous material, it was cut in such a manner as to have a thickness of 3 mm, and thus a porous material with a disk shape (12 mmø×3 mm) was obtained.

Next, in order to obtain pressure resistance to the pressure of a mobile phase, the peripheral portion of the disk-shaped porous material produced was provided with an epoxy resin clad (coating). Thus an LC column (Sample 7) was obtained.

Using Sample 7 and a commercial organic monolithic column (manufactured by BIA Separation, CIM disk), an elution chromatogram of a series of alkylbenzene and thiourea that were not held by a carrier when an acetonitrile aqueous solution (with a concentration of 80 wt %) was used as a mobile phase was measured. A mixed solution of CH₃CN and water (80:20 by volume ratio) was used as the mobile phase, and the detection wavelength was 210 nm.

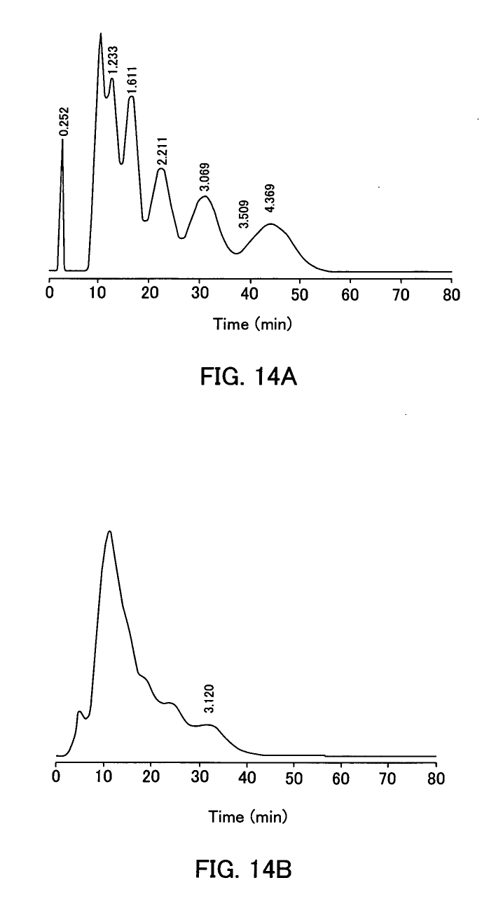

FIG. 14 shows the chromatogram obtained by the measurement. FIG. 14A shows the chromatogram obtained using Sample 7. FIG. 14B shows the chromatogram obtained using the aforementioned commercial column.

As shown in FIG. 14, Sample 7 exhibited longer retention capacity (about 1.4 times) and better separation ability with respect to alkylbenzene as compared to the commercial column.

### Example 8

In Example 8, 19 types of organic porous materials were produced using trimethylbenzene (TMB) as a polymerization solvent, polydimethylsiloxane (DMS) (referred to as “DMS-T23”) with a weight average molecular weight of 13,650 as an organic polymer, 2,2′-azobis sobutyronitrile (AIBN) as a polymerization initiator, 2,2,6,6-tetramethyl-1-piperidiniloxy (TEMPO) as a stable radical, and divinylbenzene (DVB) monomers as a low molecular compound as well as optionally further acetic anhydride (Ac₂O) as the aforementioned additional material, with different concentrations of the respective materials other than TMB and DVB in the polymerization systems and different polymerization conditions (polymerization temperature and polymerization time) being employed. Thereafter, the structures thereof were evaluated.

The amounts of the respective materials and the polymerization conditions in the respective organic porous material samples produced in Example 8 are indicated in Table 1 below.

TABLE 1

| | | | | | | | Polymerization |
|---|---|---|---|---|---|---|---|
| | Amounts of materials used | | | | | | conditions |
| Sam- | | | | | | DMS- | (Temperature/ |
| ple | DVB | TMB | AIBN | TEMPO | Ac₂O | T23 | Polymerization |
| No. | (ml) | (ml) | (g) | (g) | (ml) | (g) | time) |
| 8A | 5 | 5 | 0.02 | 0.02 | 0 | 0.475 | 125° C./48 h |
| 8B | | | | | | 0.500 | |
| 8C | | | | | | 0.525 | |
| 8D | | | | | | 0.550 | |
| 8E | | | 0.02 | 0.02 | 0 | 0.500 | 95° C./48 h |
| 8F | | | | | | 0.525 | |
| 8G | | | 0.02 | 0.05 | 0.025 | 0.475 | 95° C./48 h |
| 8H | | | | | | 0.500 | |
| 8I | | | | | | 0.525 | |
| 8J | | | | | | 0.550 | |
| 8K | | | 0.02 | 0.05 | 0.025 | 0.500 | I: 95° C./3 h |
| 8L | | | | | | 0.525 | II: 125° C./ |
| 8M | | | | | | 0.550 | 48 h |
| 8N | | | 0.05 | 0.05 | 0.025 | 0.475 | I: 95° C./3 h |
| 8O | | | | | | 0.500 | II: 125° C./ |
| 8P | | | | | | 0.525 | 48 h |
| 8Q | | | 0.02 | 0.02 | 0 | 0.500 | I: 95° C./24 h |
| 8R | | | | | | 0.525 | II: 125° C./ |
| 8S | | | | | | 0.550 | 24 h |

* In the column of “Polymerization conditions”, “h” denotes “hour”. When polymerization was carried out under two conditions, the first condition is indicated with “I:” and the condition following “I” is indicated with “II:”.

Each sample indicated in Table 1 was produced as follows.

First, a solution was formed by uniformly dissolving DMS-T23 used as an organic polymer, the amount of which is indicated in Table 1, in 5 ml of TMB used as a polymerization solvent. Next, AIBN used as a polymerization initiator, the amount of which is indicated in Table 1, TEMPO used as a stable radical, the amount of which is indicated in Table 1, and 5 ml of DVB monomers used as a low molecular compound, as well as in some samples, 0.025 ml of Ac₂O used as the aforementioned additional material were added to the solution formed as described above. After this was stirred uniformly, degassing was carried out by ultrasonic irradiation for five minutes and furthermore, nitrogen substitution was carried out for ten minutes. Subsequently, the whole was sealed, and it was subjected to polymerization under the polymerization conditions indicated in Table 1. As a result, wet gels containing the polymerization solvent were formed in all the samples.

Next, each gel thus formed was subjected to solvent substitution using tetrahydrofuran (THF). Thereafter, the whole was dried at 40° C. and thereby the polymerization solvent was removed. Thus, the respective organic porous material samples 8A to 8S were produced.

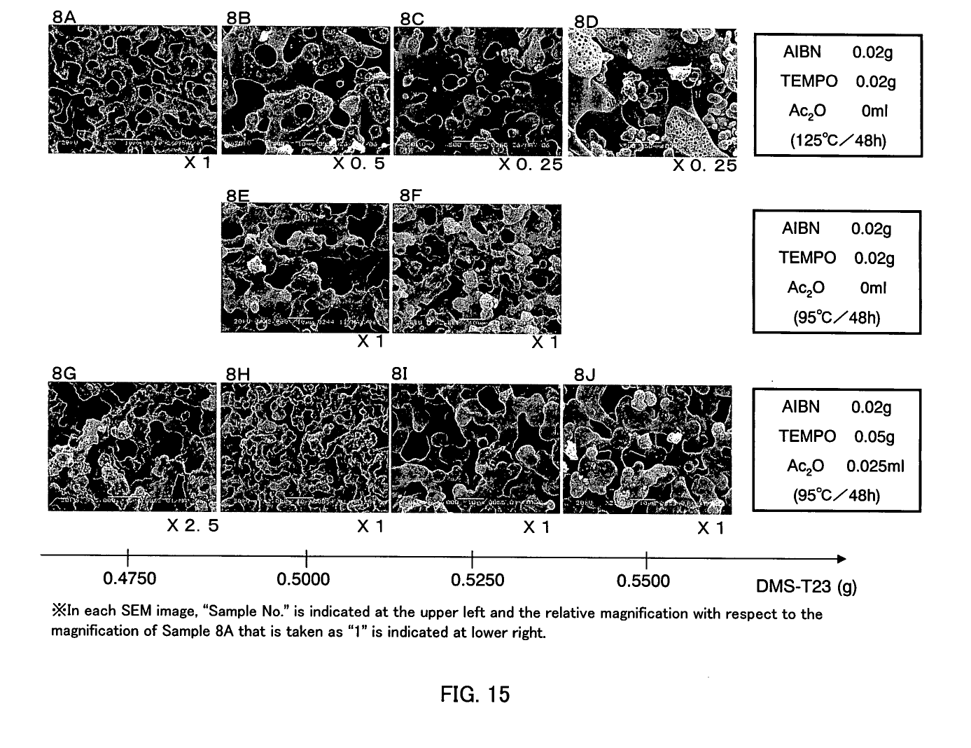

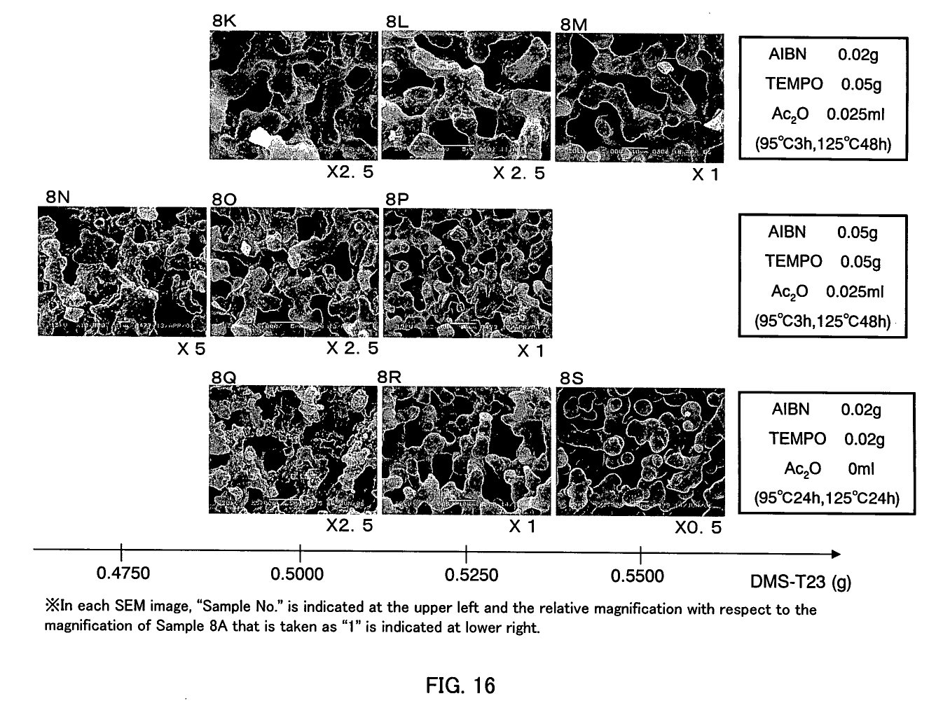

FIGS. 15 and 16 show the results of evaluations made with respect to the structures of the respective samples produced as described above. FIG. 15 shows the sections of Samples 8A to 8J measured with the SEM. FIG. 16 shows the sections of Samples 8K to 8S measured with the SEM. In FIGS. 15 and 16, the horizontal axis indicates the amount of DMS-T23 used as a phase separation inducing component. SEM images of the respective samples containing the same amount of DMS-T23 are shown in the same “row”, while SEM images of the respective samples obtained under the same conditions other than the amount of DMS-T23 are shown in the same “line”.

As shown in FIGS. 15 and 16, it was observed that in all the samples, first pores and a skeleton containing a polymer of DVB as a base material thereof were formed and the skeleton and the first pores formed a co-continuous structure.

The respective samples were subjected to fine pore distribution measurement in the same manner as in the case of Sample 1A, and thereby the peak positions of differential of fine pore volume with respect to the fine pore diameter (the first peak position corresponding to the average pore diameter of the first pores and the second peak position corresponding to the average pore diameter of the second pores) and the accumulated fine pore volume within the range of 7 nm to 220 μm of the fine pore diameter were evaluated. Furthermore, the average skeleton diameter of each sample was evaluated in the same manner as in the case of Sample 1A. Evaluation results thereof are indicated in Table 2.

TABLE 2

| | First | Second | Accumulated | Average |
|---|---|---|---|---|
| | peak | peak | fine pore | skeleton |
| Sample | position | position | volume | diameter |
| No. | (μm) | (nm) | (cm³/g) | (μm) |
| 8A | 7.5 | 2.8 | 1.45 | 3.2 |
| 8B | 14.1 | 2.0 | 1.40 | 8.8 |
| 8C | 22.4 | 2.1 | 1.35 | 35.9 |
| 8D | 68.1 | 2.2 | 1.36 | 42.5 |
| 8E | 10.2 | 6.1 | 1.46 | 4.6 |
| 8F | 8.6 | 5.8 | 1.45 | 3.8 |
| 8G | 4.0 | 8.4 | 1.46 | 2.7 |
| 8H | 3.3 | 3.5 | 1.30 | 4.5 |
| 8I | 7.6 | 2.0 | 1.40 | 6.3 |
| 8J | 8.9 | 2.8 | 1.39 | 8.4 |
| 8K | 3.1 | 5.1 | 1.42 | 2.7 |
| 8L | 4.0 | 4.9 | 1.40 | 2.5 |
| 8M | 11.4 | 2.0 | 1.42 | 5.5 |
| 8N | 2.5 | 5.9 | 1.40 | 1.8 |
| 8O | 3.6 | 4.0 | 1.38 | 2.7 |
| 8P | 7.9 | 2.1 | 1.44 | 5.1 |
| 8Q | 4.4 | 5.8 | 1.38 | 2.0 |
| 8R | 10.0 | 3.1 | 1.39 | 5.2 |
| 8S | 16.3 | 2.2 | 1.38 | 11.8 |

From the results indicated in FIGS. 15 and 16 as well as Table 2, the effects of the production conditions on the structures of the resultant organic porous materials were examined. As a result, it was found that in the resultant organic porous materials, basically, the average pore diameter of the first pores and the average skeleton diameter tended to increase as the concentration of DMS-T23 used as a phase separation inducing component increased in the polymerization system, but the accumulated fine pore volume hardly changed in this case.

When Samples 8A to 8D and Samples 8E and 8F, the production conditions for which were different only in polymerization temperature from each other, were compared to each other, it was found that the average pore diameter of the first pores and the average skeleton diameter tended to increase with an increase in polymerization temperature.

When Samples 8K to 8M and Samples 8N to 8P, which were different only in concentration of AIBN used as a polymerization initiator in the polymerization system, were compared to each other, it was found that the average pore diameter of the first pores tended to increase with an increase in concentration of AIBN in the polymerization system. Conceivably, it also is possible to control the pore diameter of the first pore (macropore diameter) by increasing or decreasing the concentration of the polymerization initiator (conceivably, the same applies to the stable radical) in the polymerization system. It is conceivable that when the concentration of the polymerization initiator (stable radical) is low in the polymerization system, the average polymerization degree of the DVB polymer increases before gelation proceeds, which results in a short gelation time. Since the macropore diameter depends on the timing of phase separation and gelation, a shorter gelation time results in formation of an undeveloped phase separation structure, that is, a decrease in macropore diameter. On the contrary, the following is conceivable. That is, when the concentration of the polymerization initiator (stable radical) is high in the polymerization system, multiple polymerization reactions occur at the same time, and thereby the average polymerization degree of the DVB polymer increases slowly, which results in a longer gelation time. A longer gelation time results in formation of further developed phase separation structure, that is, an increase in macropore diameter.

In Sample 8A to 8S, AIBN was used as a polymerization initiator. In the case of using AIBN, probably due to better polymerization reactions as compared to the case of using BPO as a polymerization initiator as in Examples 2 to 6, organic porous materials having good co-continuous structures were formed even under the polymerization conditions that were considered to cause polymerization to proceed slower (Samples 8A to 8J) as compared to the polymerization conditions (at 95° C. for 90 minutes and thereafter, at 125° C. for 48 hours) of Examples 2 to 6.

### Example 9

In Example 9, as in Example 8, 15 types of organic porous materials were produced using TMB as a polymerization solvent, DMS-T23 as an organic polymer, AIBN as a polymerization initiator, TEMPO as a stable radical, and DVB monomers as a low molecular compound as well as optionally further Ac₂O as the aforementioned additional material, with different concentrations of the respective materials other than TMB and DVB in the polymerization systems and different polymerization conditions (polymerization temperature and polymerization time) being employed. Thereafter, the structures thereof were evaluated.

The amounts of the aforementioned respective materials and the polymerization conditions in each organic porous material sample produced in Example 9 are indicated in Table 3 below.

TABLE 3

| | | | | | | | Polymerization |
|---|---|---|---|---|---|---|---|
| | Amounts of materials used | | | | | | conditions |
| Sam- | | | | | | DMS- | (Temperature/ |
| ple | DVB | TMB | AIBN | TEMPO | Ac₂O | T23 | Polymerization |
| No. | (ml) | (ml) | (g) | (g) | (ml) | (g) | time) |
| 9A | 5 | 6 | 0.02 | 0.02 | 0 | 0.550 | 125° C./48 h |
| 9B | | | | | | 0.575 | |
| 9C | | | 0.02 | 0.02 | 0 | 0.575 | 95° C./48 h |
| 9D | | | | | | 0.600 | |
| 9E | | | 0.02 | 0.05 | 0.025 | 0.550 | 95° C./48 h |
| 9F | | | | | | 0.575 | |
| 9G | | | | | | 0.600 | |
| 9H | | | 0.02 | 0.05 | 0.025 | 0.575 | I: 95° C./3 h |
| 9I | | | | | | 0.600 | II: 125° C./ |
| 9J | | | | | | 0.625 | 48 h |
| 9K | | | 0.05 | 0.05 | 0.025 | 0.550 | I: 95° C./3 h |
| | | | | | | | II: 125° C./ |
| | | | | | | | 48 h |
| 9L | | | 0.02 | 0.02 | 0 | 0.550 | I: 95° C./24 h |
| 9M | | | | | | 0.575 | II: 125° C./ |
| 9N | | | | | | 0.600 | 24 h |
| 9O | | | | | | 0.625 | |

* In the column of “Polymerization conditions”, “h” denotes “hour”. When polymerization was carried out under two conditions, the first condition is indicated with “I:” and the condition following “I” is indicated with “II:”.

Each sample indicated in Table 3 was produced as follows.

First, a solution was formed by uniformly dissolving DMS-T23 used as an organic polymer, the amount of which is indicated in Table 3, in 6 ml of TMB used as a polymerization solvent. Next, AIBN used as a polymerization initiator, the amount of which is indicated in Table 3, TEMPO used as a stable radical, the amount of which is indicated in Table 3, and 5 ml of DVB monomers used as a low molecular compound, as well as in some samples, 0.025 ml of Ac₂O used as the aforementioned additional material were added to the solution formed as described above. After this was stirred uniformly, degassing was carried out by ultrasonic irradiation for five minutes and furthermore, nitrogen substitution was carried out for ten minutes. Subsequently, the whole was sealed, and it was subjected to polymerization under the polymerization conditions indicated in Table 3. As a result, wet gels containing the polymerization solvent were formed in all the samples.

Next, each gel thus formed was subjected to solvent substitution using THF. Thereafter, the whole was dried at 40° C. and thereby the polymerization solvent was removed. Thus, the respective organic porous material samples 9A to 9O were produced.

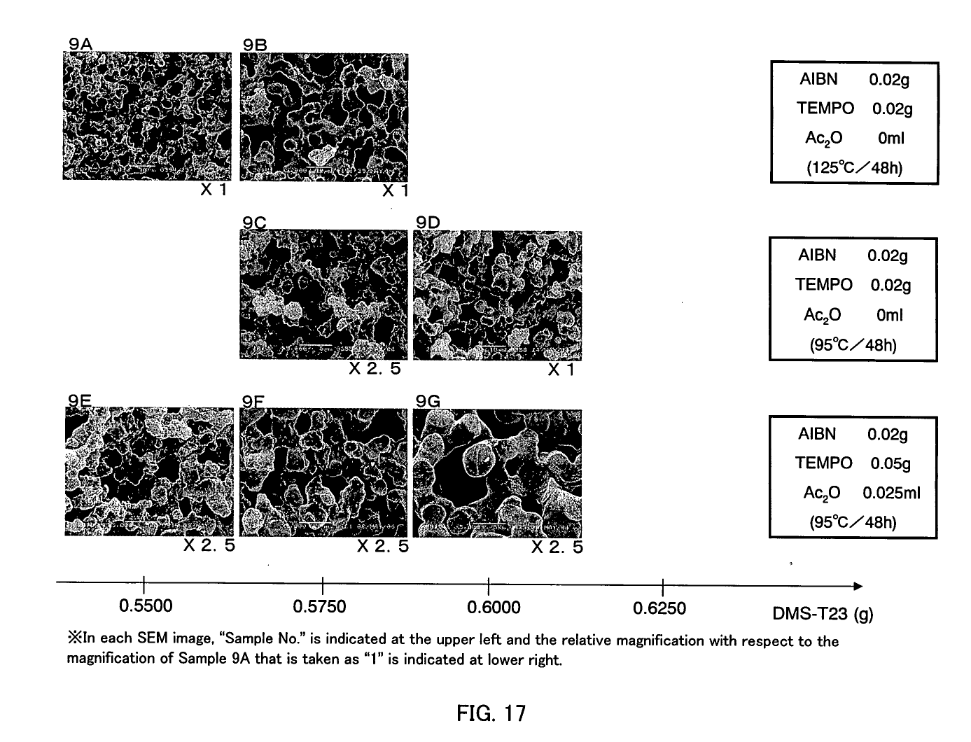

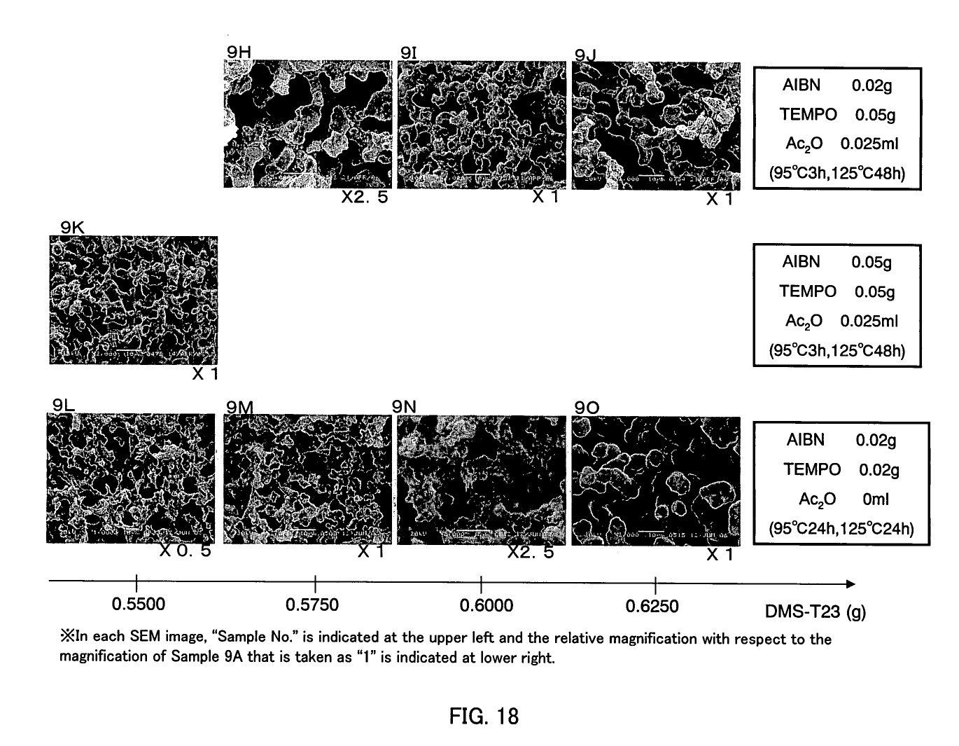

FIGS. 17 and 18 show the results of evaluations made with respect to the structures of the respective samples produced as described above.

FIG. 17 shows the sections of Samples 9A to 9G measured with the SEM. FIG. 18 shows the sections of Samples 9H to 9O measured with the SEM. In FIGS. 17 and 18, the horizontal axis indicates the amount of DMS-T23 used as a phase separation inducing component. SEM images of the respective samples containing the same amount of DMS-T23 are shown in the same “row”, while SEM images of the respective samples obtained under the same conditions other than the amount of DMS-T23 are shown in the same “line”.

As shown in FIGS. 17 and 18, it was observed that in all the samples, first pores and a skeleton containing a polymer of DVB as a base material thereof were formed and the skeleton and the first pores formed a co-continuous structure.

The respective samples were subjected to fine pore distribution measurement in the same manner as in the case of Sample 1A, and thereby the peak positions of differential of fine pore volume with respect to the fine pore diameter (the first peak position corresponding to the average pore diameter of the first pores and the second peak position corresponding to the average pore diameter of the second pores) and the accumulated fine pore volume within the range of 7 nm to 220 μm of the fine pore diameter were evaluated. Furthermore, the average skeleton diameter of each sample was evaluated in the same manner as in the case of Sample 1A. Evaluation results thereof are indicated in Table 4.

TABLE 4

| | First | Second | Accumulated | Average |
|---|---|---|---|---|
| | peak | peak | fine pore | skeleton |
| Sample | position | position | volume | diameter |
| No. | (μm) | (nm) | (cm³/g) | (μm) |
| 9A | 5.5 | 5.2 | 1.60 | 2.5 |
| 9B | 7.2 | 2.9 | 1.58 | 5.1 |
| 9C | 2.9 | 4.4 | 1.61 | 1.9 |
| 9D | 3.1 | 4.0 | 1.61 | 2.0 |
| 9E | 3.4 | 6.1 | 1.62 | 3.0 |
| 9F | 4.0 | 3.8 | 1.60 | 3.0 |
| 9G | 7.4 | 3.0 | 1.58 | 3.4 |
| 9H | 5.6 | 6.0 | 1.60 | 2.5 |
| 9I | 7.0 | 4.8 | 1.59 | 3.3 |
| 9J | 8.9 | 2.4 | 1.59 | 4.0 |
| 9K | 4.3 | 7.8 | 1.61 | 2.1 |
| 9L | 10.6 | 5.4 | 1.63 | 4.4 |
| 9M | 5.3 | 6.1 | 1.60 | 3.4 |
| 9N | 2.0 | 10.2 | 1.64 | 0.86 |
| 9O | 8.3 | 3.5 | 1.61 | 4.3 |

From the results indicated in FIGS. 17 and 18 as well as Table 4, the effects of the production conditions on the structures of the resultant organic porous materials were examined. As a result, it was found that in the resultant organic porous materials, basically, the average pore diameter of the first pores and the average skeleton diameter tended to increase as the concentration of DMS-T23 used as a phase separation inducing component increased in the polymerization system, but the accumulated fine pore volume hardly changed in this case.

When Sample 9B and Sample 9C, the production conditions for which were different only in polymerization temperature from each other, were compared to each other, it was found that in Sample 9B obtained using a higher polymerization temperature, the average pore diameter of the first pores and the average skeleton diameter tended to increase more.

### Example 10

In Example 10, 30 types of organic porous materials were produced using TMB as a polymerization solvent, DMS-T23 as an organic polymer, AIBN as a polymerization initiator, TEMPO as a stable radical, and DVB monomers as a low molecular compound as well as optionally further Ac₂O as the aforementioned additional material, with different concentrations of the respective materials other than TMB and DVB in the polymerization systems and different polymerization conditions (polymerization temperature and polymerization time) being employed. Thereafter, the structures thereof were evaluated.

The amounts of the aforementioned respective materials and the polymerization conditions in each organic porous material sample produced in Example 10 are indicated in Tables 5 and 6 below.

TABLE 5.

| | | | | | | | Polymerization |
|---|---|---|---|---|---|---|---|
| | Amounts of materials used | | | | | | conditions |
| Sam- | | | | | | DMS- | (Temperature/ |
| ple | DVB | TMB | AIBN | TEMPO | Ac₂O | T23 | Polymerization |
| No. | (ml) | (ml) | (g) | (g) | (ml) | (g) | time) |
| 10A | 5 | 7 | 0.02 | 0.02 | 0 | 0.625 | I: 95° C./24 h |
| 10B | | | | | | 0.650 | II: 125° C./ |
| 10C | | | | | | 0.675 | 24 h |
| 10D | | | | | | 0.700 | |
| 10E | | | 0.02 | 0.02 | 0 | 0.625 | 125° C./48 h |
| 10F | | | | | | 0.650 | |
| 10G | | | | | | 0.675 | |
| 10H | | | | | | 0.700 | |
| 10I | | | 0.02 | 0.02 | 0 | 0.625 | 95° C./48 h |
| 10J | | | | | | 0.650 | |
| 10K | | | | | | 0.675 | |
| 10L | | | 0.02 | 0.05 | 0.025 | 0.625 | 95° C./48 h |
| 10M | | | | | | 0.650 | |
| 10N | | | | | | 0.675 | |
| 10O | | | 0.02 | 0.05 | 0.025 | 0.625 | I: 95° C./3 h |
| 10P | | | | | | 0.650 | II: 125° C./ |
| 10Q | | | | | | 0.675 | 48 h |
| 10R | | | | | | 0.700 | |

* In the column of “Polymerization conditions”, “h” denotes “hour”. When polymerization was carried out under two conditions, the first condition is indicated with “I:” and the condition following “I” is indicated with “II:”.

TABLE 6

| | | | | | | | Polymerization |
|---|---|---|---|---|---|---|---|
| | Amounts of materials used | | | | | | conditions |
| Sam- | | | | | | DMS- | (Temperature/ |
| ple | DVB | TMB | AIBN | TEMPO | Ac₂O | T23 | Polymerization |
| No. | (ml) | (ml) | (g) | (g) | (ml) | (g) | time) |
| 10S | 5 | 8 | 0.02 | 0.02 | 0 | 0.675 | I: 95° C./24 h |
| 10T | | | | | | 0.700 | II: 125° C./ |
| 10U | | | | | | 0.725 | 24 h |
| 10V | | | | | | 0.750 | |
| 10W | | | 0.02 | 0.02 | 0 | 0.750 | 125° C./48 h |
| 10X | | | 0.02 | 0.05 | 0.025 | 0.675 | 95° C./48 h |
| 10Y | | | | | | 0.700 | |
| 10Z | | | | | | 0.725 | |
| 10α | | | | | | 0.750 | |
| 10β | | | 0.02 | 0.05 | 0.025 | 0.700 | I: 95° C./3 h |
| 10γ | | | | | | 0.725 | II: 125° C./ |
| 10δ | | | | | | 0.750 | 48 h |

* In the column of “Polymerization conditions”, “h” denotes “hour”. When polymerization was carried out under two conditions, the first condition is indicated with “I:” and the condition following “I” is indicated with “II:”.

Each sample indicated in Tables. 5 and 6 was produced as follows.

First, a solution was formed by uniformly dissolving DMS-T23 used as an organic polymer, the amount of which is indicated in Table 5 or 6, in 7 ml (Table 5) or 8 ml (Table 6) of TMB used as a polymerization solvent. Next, AIBN used as a polymerization initiator, the amount of which is indicated in Table 5 or 6, TEMPO used as a stable radical, the amount of which is indicated in Table 5 or 6, and 5 ml of DVB monomers used as a low molecular compound as well as in some samples, 0.025 ml of Ac₂O used as the aforementioned additional material were added to the solution formed as described above. After this was stirred uniformly, degassing was carried out by ultrasonic irradiation for five minutes and furthermore, nitrogen substitution was carried out for ten minutes. Subsequently, the whole was sealed, and it was subjected to polymerization under the polymerization conditions indicated in Table 5 or 6. As a result, wet gels containing the polymerization solvent were formed in all the samples.

Next, each gel thus formed was subjected to solvent substitution using THF. Thereafter, the whole was dried at 40° C. and thereby the polymerization solvent was removed. Thus, the respective organic porous material samples 10A to 10δ were produced. As a result, it was observed that in all the samples, first pores and a skeleton containing a polymer of DVB as a base material thereof were formed and the skeleton and the first pores formed a co-continuous structure.

Subsequently, the respective samples were subjected to fine pore distribution measurement in the same manner as in the case of Sample 1A, and thereby the peak positions of differential of fine pore volume with respect to the fine pore diameter (the first peak position corresponding to the average pore diameter of the first pores and the second peak position corresponding to the average pore diameter of the second pores) and the accumulated fine pore volume within the range of 7 nm to 220 μm of the fine pore diameter were evaluated. Furthermore, the average skeleton diameter of each sample was evaluated in the same manner as in the case of Sample 1A. Evaluation results thereof are indicated in Tables 7 and 8.

TABLE 7

| | First | Second | Accumulated | Average |
|---|---|---|---|---|
| | peak | peak | fine pore | skeleton |
| Sample | position | position | volume | diameter |
| No. | (μm) | (nm) | (cm³/g) | (μm) |
| 10A | 7.6 | 6.3 | 2.12 | 2.9 |
| 10B | 7.3 | 6.0 | 2.12 | 2.4 |
| 10C | 37.6 | 2.1 | 2.10 | 11.5 |
| 10D | 20.3 | 2.0 | 2.10 | 7.9 |
| 10E | 0.87 | 7.7 | 2.14 | 0.51 |
| 10F | 4.2 | 5.3 | 2.14 | 1.8 |
| 10G | 12.6 | 3.4 | 2.10 | 6.3 |
| 10H | 16.8 | 2.4 | 2.11 | 8.9 |
| 10I | 0.71 | 8.9 | 2.12 | 0.41 |
| 10J | 8.8 | 3.5 | 2.11 | 3.7 |
| 10K | 9.0 | 3.0 | 2.13 | 4.1 |
| 10L | 3.8 | 5.9 | 2.10 | 2.2 |
| 10M | 7.1 | 3.4 | 2.10 | 5.2 |
| 10N | 8.8 | 2.9 | 2.15 | 6.8 |
| 10O | 0.32 | 10.9 | 2.13 | 0.10 |
| 10P | 7.0 | 4.2 | 2.12 | 3.4 |
| 10Q | 10.9 | 4.0 | 2.10 | 3.0 |
| 10R | 7.9 | 2.2 | 2.09 | 6.7 |

TABLE 8

| | First | Second | Accumulated | Average |
|---|---|---|---|---|
| | peak | peak | fine pore | skeleton |
| Sample | position | position | volume | diameter |
| No. | (μm) | (nm) | (cm³/g) | (μm) |
| 10S | 0.94 | 10.1 | 2.30 | 0.40 |
| 10T | 2.8 | 7.4 | 2.30 | 1.1 |
| 10U | 7.6 | 5.0 | 2.24 | 3.7 |
| 10V | 7.3 | 4.8 | 2.26 | 2.9 |
| 10W | 9.5 | 2.6 | 2.28 | 5.9 |
| 10X | 2.8 | 7.7 | 2.30 | 1.1 |
| 10Y | 3.0 | 6.6 | 2.31 | 1.2 |
| 10Z | 4.1 | 3.7 | 2.30 | 2.1 |
| 10α | 6.2 | 2.8 | 2.27 | 4.7 |
| 10β | 2.1 | 10.5 | 2.32 | 0.87 |
| 10γ | 3.7 | 7.8 | 2.31 | 0.90 |
| 10δ | 7.2 | 5.9 | 2.27 | 3.4 |

From the results indicated in Tables 7 and 8, the effects of the production conditions on the structures of the resultant organic porous materials were examined. As a result, it was found that in the resultant organic porous materials, basically, the average pore diameter of the first pores and the average skeleton diameter tended to increase as the concentration of DMS-T23 used as a phase separation inducing component increased in the polymerization system, but the accumulated fine pore volume hardly changed in this case.

Moreover, with respect to, for example, the polymerization conditions or the concentration of AIBN used as a polymerization initiator, Samples 10A to 10δ exhibited similar tendencies to those of the respective samples of Examples 8 and 9.

### Example 11

In Example 11, 6 types of organic porous materials were produced using TMB as a polymerization solvent, DMS with a weight average molecular weight of 17,250 (referred to as “DMS-T25”) as an organic polymer, AIBN as a polymerization initiator, TEMPO as a stable radical, and DVB monomers as a low molecular compound, with different concentrations of TMB and DMS-T25 being employed in the polymerization systems. Thereafter, the structures thereof were evaluated.

The amounts of the aforementioned respective materials and the polymerization conditions in each organic porous material sample produced in Example 11 are indicated in Table 9 below.

TABLE 9

| | | | | | | | Polymerization |
|---|---|---|---|---|---|---|---|
| | Amounts of materials used | | | | | | conditions |
| Sam- | | | | | | DMS- | (Temperature/ |
| ple | DVB | TMB | AIBN | TEMPO | Ac₂O | T23 | Polymerization |
| No. | (ml) | (ml) | (g) | (g) | (ml) | (g) | time) |
| 11A | 5 | 5 | 0.02 | 0.02 | 0 | 0.400 | 125° C./48 h |
| 11B | | | | | | 0.425 | |
| 11C | | | | | | 0.450 | |
| 11D | | 6 | | | | 0.450 | |
| 11E | | | | | | 0.475 | |
| 11F | | | | | | 0.500 | |

Each sample indicated in Table 9 was produced as follows.

First, a solution was formed by uniformly dissolving DMS-T25 used as an organic polymer, the amount of which is indicated in Table 9, in TMB used as a polymerization solvent, the amount of which is indicated in Table 9. Next, 0.02 g of AIBN used as a polymerization initiator, 0.02 g of TEMPO used as a stable radical, and 5 ml of DVB monomers used as a low molecular compound were added to the solution formed as described above. After this was stirred uniformly, degassing was carried out by ultrasonic irradiation for five minutes and furthermore, nitrogen substitution was carried out for ten minutes. Subsequently, the whole was sealed, and it was subjected to polymerization under the polymerization conditions indicated in Table 9. As a result, wet gels containing the polymerization solvents were formed in all the samples.

Next, each gel thus formed was subjected to solvent substitution using THF. Thereafter, the whole was dried at 40° C. and thereby the polymerization solvent was removed. Thus, the respective organic porous material samples 11A to 11F were produced.

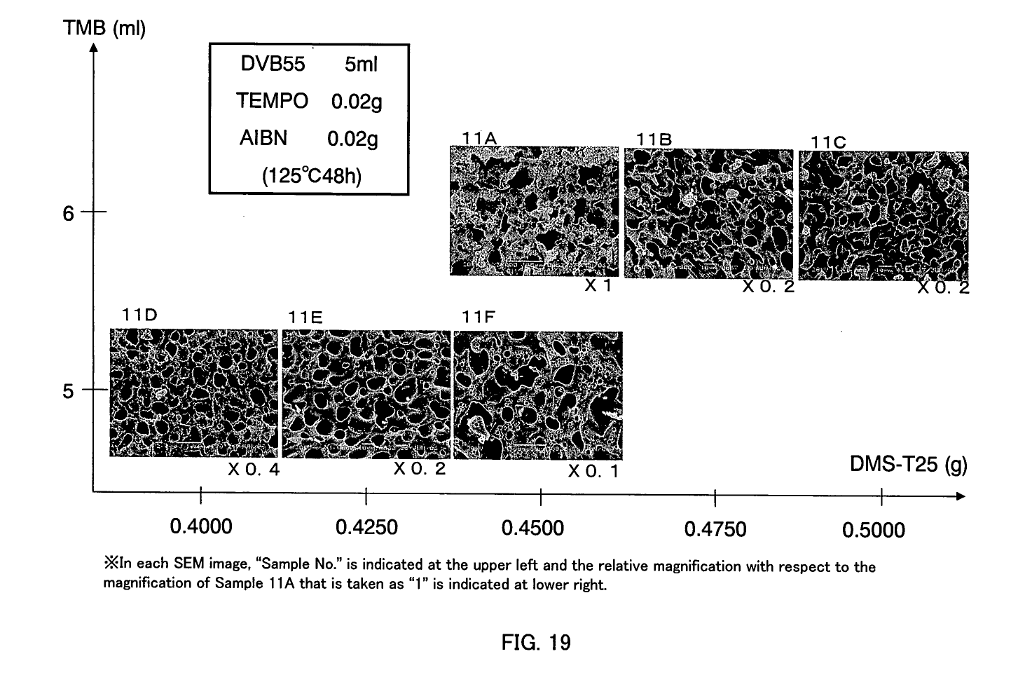

FIG. 19 shows the results of evaluations made with respect to the structures of the respective samples produced as described above. FIG. 19 shows the sections of Samples 11A to 11F measured with the SEM. In FIG. 19, the horizontal axis indicates the amount of DMS-T25 used as a phase separation inducing component. SEM images of the respective samples containing the same amount of DMS-T25 are shown in the same “row”, while SEM images of the respective samples obtained under the same conditions other than the amount of DMS-T25 are shown in the same “line”.

As shown in FIG. 19, it was observed that in all the samples, first pores and a skeleton containing a polymer of DVB as a base material thereof were formed and the skeleton and the first pores formed a co-continuous structure.

The respective samples were subjected to fine pore distribution measurement in the same manner as in the case of Sample 1A, and thereby the peak positions of differential of fine pore volume with respect to the fine pore diameter (the first peak position corresponding to the average pore diameter of the first pores and the second peak position corresponding to the average pore diameter of the second pores) and the accumulated fine pore volume within the range of 7 nm to 220 μm of the fine pore diameter were evaluated. Furthermore, the average skeleton diameter of each sample was evaluated in the same manner as in the case of Sample 1A. Evaluation results thereof are indicated in Table 10.

TABLE 10

| | First | Second | Accumulated | Average |
|---|---|---|---|---|
| | peak | peak | fine pore | skeleton |
| Sample | position | position | volume | diameter |
| No. | (μm) | (nm) | (cm³/g) | (μm) |
| 11A | 2.9 | 6.9 | 1.40 | 1.0 |
| 11B | 12.3 | 3.9 | 1.42 | 8.8 |
| 11C | 12.9 | 4.0 | 1.43 | 8.7 |
| 11D | 6.9 | 5.2 | 1.38 | 3.9 |
| 11E | 12.1 | 2.7 | 1.37 | 8.1 |
| 11F | 31.7 | 2.2 | 1.37 | 12.9 |

From the results indicated in FIG. 19 and Table 10, the effects of the production conditions on the structures of the resultant organic porous materials were examined. As a result, it was found that in the resultant organic porous materials, basically, the average pore diameter of the first pores and the average skeleton diameter tended to increase as the concentration of DMS-T25 used as a phase separation inducing component increased in the polymerization system, but the accumulated fine pore volume hardly changed in this case.

Next, organic porous materials were formed in the same manner as in the cases of Samples 11A to 11F, with the amount of DMS-T25 to be added to the polymerization system being changed in the range of 0.525 g to 0.625 g. As a result, organic porous materials were formed, each of which had a co-continuous structure of first pores and a skeleton containing a polymer of DVB as a base material thereof. In this case, the amount of TMB used as a polymerization solvent was changed in the range of 6 to 8 ml according to the amount of DMS-T25.

Organic porous materials were formed in the same manner as in the cases of Samples 11A to 11F except that DMS with a weight average molecular weight of 62,700 (referred to as “DMS-T41”) was used as an organic polymer. Thereafter, the structures thereof were evaluated. As a result, organic porous materials were formed, each of which had a co-continuous structure of first pores and a skeleton containing a polymer of DVB as a base material thereof. In this case, the amount of TMB used as a polymerization solvent was changed in the range of 7 to 9 ml according to the amount of DMS-T41 (0.100 g to 0.300 g).

### Example 12

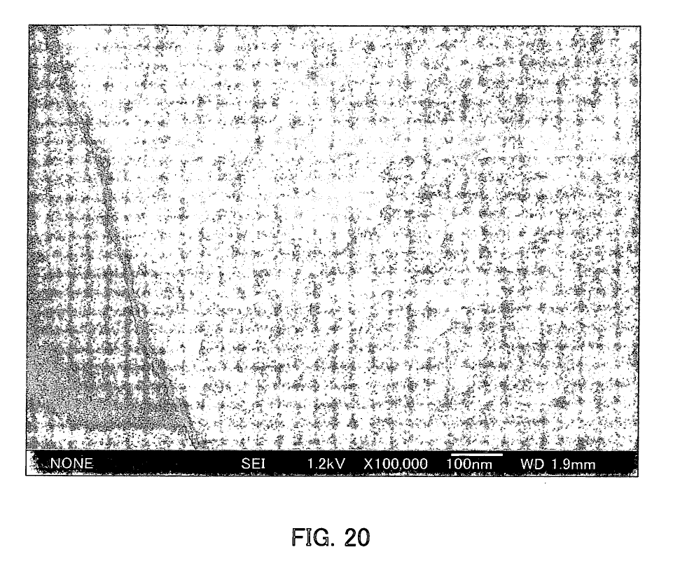

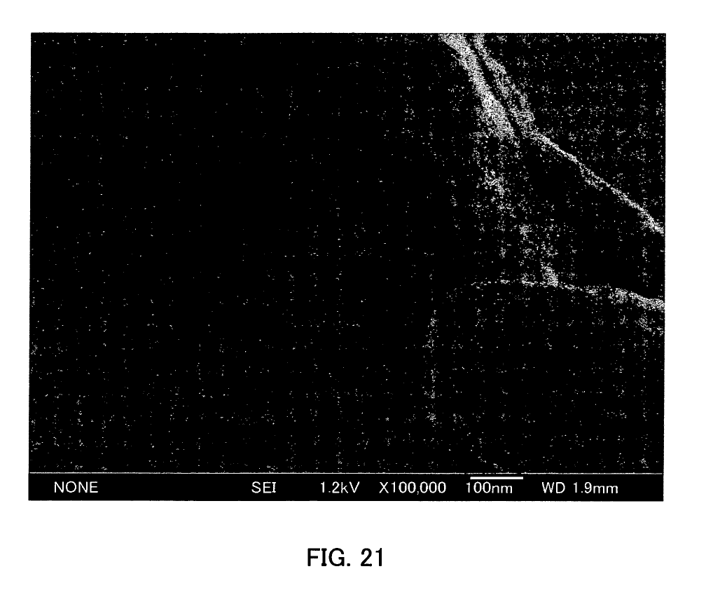

In Example 12, Sample 8E produced in Example 8 was heat-treated. The surface of the sample was observed with a field emission scanning electron microscope (FE-SEM) before and after the heat treatment. The heat treatment was carried out at 200° C. for six hours in an air atmosphere. FIG. 20 shows the surface of Sample 8E before heat treatment, and FIG. 21 shows the surface of Sample 8E after heat treatment.

As shown in FIGS. 20 and 21, it was proved that countless second pores (mesopores) observed at the surface of the skeleton before the heat treatment had disappeared after heat treatment. The fine pore distribution measurement was carried out with respect to Sample 8E after heat treatment in the same manner as in the case of Sample 1A. As a result, the peak that indicated the second pores corresponding to mesopores had disappeared. From this result, it was proved that in the production process of the present invention, the further use of the heat treatment in combination also made it possible to form an organic porous material whose surface was controlled with further detail, more specifically, an organic porous material with hardly any mesopores.

### Example 13

In Example 13, 8 types of organic porous materials were produced using TMB as a polymerization solvent, DMS-T23 as an organic polymer, benzoyl peroxide (BPO) as a polymerization initiator, TEMPO as a stable radical, and DVB monomers as a low molecular compound as well as acetic anhydride (Ac₂O) as the aforementioned additional material, with different concentrations of TMB and DMS being employed in the polymerization systems. Thereafter, the structures thereof were evaluated.

The amounts of the aforementioned respective materials and the polymerization conditions in each organic porous material sample produced in Example 13 are indicated in Table 11 below.

TABLE 11

| | | | | | | | Polymerization |
|---|---|---|---|---|---|---|---|
| | | | | | | | conditions |
| Sam- | Amounts of materials used | | | | | | (Temperature/ |
| ple | DVB | TMB | BPO | TEMPO | Ac₂O | DMS | Polymerization |
| No. | (ml) | (ml) | (g) | (g) | (ml) | (g) | time) |
| 13A | 10 | 14 | 0.1 | 0.1 | 0.05 | 1.10 | I: 95° C./1.5 h |
| 13B | | | | | | 1.15 | II: 125° C./48 h |
| 13C | | | | | | 1.20 | |
| 13D | | | | | | 1.25 | |
| 13E | | 16 | | | | 1.30 | |
| 13F | | | | | | 1.35 | |
| 13G | | | | | | 1.40 | |
| 13H | | 18 | | | | 1.40 | |

Each sample indicated in Table 11 was produced as follows.

First, a solution was formed by uniformly dissolving DMS used as an organic polymer, the amount of which is indicated in Table 11, in TMB used as a polymerization solvent, the amount of which is indicated in Table 11. Next, 0.1 g of BPO used as a polymerization initiator, 0.1 g of TEMPO used as a stable radical, 10 ml of DVB monomers used as a low molecular compound, and 0.05 ml of Ac₂O used as the aforementioned additional material were added to the solution formed as described above. After this was stirred uniformly, degassing was carried out by ultrasonic irradiation for five minutes and furthermore, nitrogen substitution was carried out for ten minutes. Subsequently, the whole was sealed, and it was subjected to polymerization for about 90 minutes at a temperature increased to 95° C. and then for 48 hours at a temperature increased to 125° C. As a result, a wet gel containing the polymerization solvent was formed.

Next, each gel thus formed was subjected to solvent substitution using THF. Thereafter, the whole was dried at 40° C. and thereby the polymerization solvent was removed. Thus, the respective organic porous material samples 13A to 13H were produced.

The structures of Samples 13A to 13H thus produced were evaluated with the SEM. As a result, it was observed that first pores and a skeleton containing a polymer of DVB as a base material thereof were formed and the skeleton and the first pores formed a co-continuous structure.

Samples 13A to 13H were subjected to fine pore distribution measurement by the mercury intrusion method and the nitrogen adsorption method as well as skeletal density measurement by densimetry using helium. The skeletal density was determined using AccuPyc 1330 manufactured by Micromeritics Instrument Corporation as the measurement apparatus, by measuring the skeletal volume of each sample by a fixed volume expansion method and then dividing the weight of the sample by the skeletal volume thus measured.

Table 12 shown below indicates the skeletal density, average pore diameter of first pores (macropores), accumulated fine pore volume within the range of 7 nm to 200 μm of the fine pore diameter, porosity, and BET specific surface area of each sample, which were obtained by the aforementioned measurements.

TABLE 12

| | | | | | BET |
|---|---|---|---|---|---|
| | | Average pore | Accumulated | | specific |
| | Skeletal | diameter of | fine pore | | surface |
| Sample | density | first pores | volume | Porosity | area |
| No. | (g/cm³) | (μm) | (cm³/g) | (%) | (m²/g) |
| 13A | 1.12 | 0.389 | 1.59 | 64.6 | 683 |
| 13B | 1.11 | 0.838 | 1.60 | 63.4 | 622 |
| 13C | 1.12 | 2.25 | 1.58 | 62.5 | 604 |
| 13D | 1.14 | 4.15 | 1.48 | 61.5 | 546 |
| 13E | 1.13 | 1.16 | 1.70 | 65.9 | 613 |
| 13F | 1.12 | 2.47 | 1.77 | 66.7 | 662 |
| 13G | 1.16 | 3.90 | 1.65 | 64.7 | 439 |
| 13H | 1.13 | 2.75 | 1.99 | 69.7 | 616 |

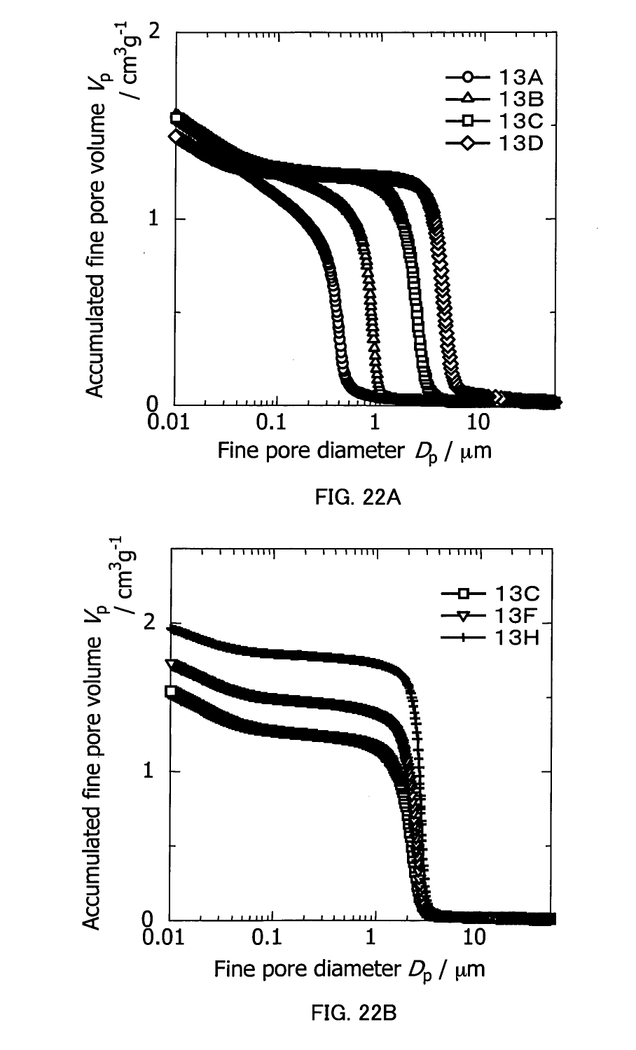

FIG. 22A shows the results of the fine pore distribution measurement carried out by the mercury intrusion method with respect to Samples 13A˜13D. FIG. 22B shows the results of the fine pore distribution measurement carried out by the mercury intrusion method with respect to Samples 13C, 13F, and 13H.

As shown in Table 12 and FIG. 22A, when Samples 13A to 13D were compared to one another, it was proved that it was possible to increase the average pore diameter of the first pores by increasing the concentration of DMS used as a phase separation inducing component in the polymerization system, while hardly changing the skeletal density and accumulated fine pore volume.

As shown in Table 12 and FIG. 22B, when Samples 13C, 13F, and 13H are compared to one another, it was proved that it was possible to increase the accumulated fine pore volume by increasing the concentration of TMB used as a polymerization solvent and controlling the concentration of DMS in the polymerization system, while hardly changing the average pore diameter of the first pores.

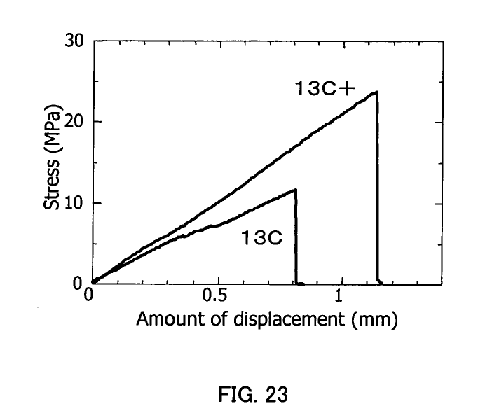

Next, with respect to Sample 13C, the bending strength thereof was evaluated by a three-point bending test. The measurement of the bending strength was carried out with respect to Sample 13C that had been subjected to air drying alone after being produced and Sample 13C that had been subjected to air drying and a further heat treatment carried out at 200° C. for 12 hours after being produced (hereinafter, referred to as “Sample 13C+”). Specifically, Sample 13C and Sample 13C+were cylindrical samples (span L=30 mm) with a diameter d of 5.73 mm and a diameter d of 5.50 mm, respectively. The bending strength was measured while a load P was applied onto the respective samples at a crosshead speed of 0.5 mm/min. The stress σ was calculated from a formula σ=8 PL/πd³. FIG. 23 shows the relationship between the amount of displacement and the stress during measurement.

As shown in FIG. 23, Samples 13C and 13C+had a bending strength of 4.78 MPa and 11.02 MPa, respectively. According to the paper “Bending strength of silica gel with bimodalpores: Effect of variation in mesopore structure, Ryoji Takahashi et al., Material Research Bulletin 40 (2005) 1148-1156”, concerning the bending strength of silica gel, heat-treated silica gel having a similar structure to those of Samples 13C and 13C+ has a bending strength of up to about 5 MPa. Accordingly, it was proved that Samples 13C and 13C+had strength that was substantially equal to or higher than that of a porous material formed of such a heat-treated silica gel.

The present invention is applicable to other embodiments as long as they do not depart from the spirit and essential characteristics thereof. The embodiments disclosed in this specification are to be considered in all respects as illustrative and not limiting. The scope of the present invention is indicated by the appended claims rather than by the foregoing description, and all changes that come within the meaning and range of equivalency of the claims are intended to be embraced therein.

### INDUSTRIAL APPLICABILITY

According to the present invention, after a gel with a co-continuous structure of a skeletal phase and a solvent phase is formed by living radical polymerization or anionic polymerization of a low molecular compound in the presence of an organic polymer to be used as a phase separation inducing component, an organic porous material can be obtained that has a co-continuous structure formed of a skeleton and pores (first pores). This organic porous material can be a porous material that is excellent in mechanical properties such as strength and that has a structure of a skeleton and pores (first and second pores) that is controlled more precisely.

1. A process for producing an organic porous material, comprising:
(i) subjecting a low molecular compound having living radical polymerizability and/or anionic polymerizability to living radical polymerization or anionic polymerization in a system including the low molecular compound, an organic polymer to be used as a phase separation inducing component, a polymerization initiator, and a polymerization solvent, and
thereby forming a gel that includes a skeletal phase rich in a polymer of the low molecular compound and a solvent phase rich in the polymerization solvent and that has a co-continuous structure formed of the skeletal phase and the solvent phase, and
(ii) removing the polymerization solvent from the gel thus formed to form a skeleton containing the polymer as a base material thereof from the skeletal phase while forming a first pore from the solvent phase, and thereby obtaining an organic porous material with a co-continuous structure formed of the skeleton and the first pore.

2. The process for producing an organic porous material according to claim 1, wherein the skeletal phase and the solvent phase are formed by phase separation of a spinodal decomposition type.

3. The process for producing an organic porous material according to claim 1, wherein in step (i), a solution is formed by dissolving the organic polymer in the polymerization solvent, and the system is formed by mixing the solution thus formed, the polymerization initiator, and the low molecular compound together.

4. The process for producing an organic porous material according to claim 1, wherein the low molecular compound that is subjected to polymerization in the system is at least two types of low molecular compounds.

5. The process for producing an organic porous material according to claim 4, wherein at least one type of the two types of the low molecular compounds is a polyfunctional low molecular compound having at least two carbon-carbon multiple bonds, and
the proportion of the polyfunctional low molecular compound in the low molecular compound is at least 33.3 vol %.

6. The process for producing an organic porous material according to claim 5, wherein the proportion of the polyfunctional low molecular compound in the low molecular compound is at least 50 vol %.

7. The process for producing an organic porous material according to claim 1, wherein the low molecular compound has at least two carbon-carbon multiple bonds.

8. The process for producing an organic porous material according to claim 1, wherein the low molecular compound has at least one group selected from a vinyl group and an allyl group.

9. The process for producing an organic porous material according to claim 1, wherein an average pore diameter of the first pore is in a range exceeding 100 nm but not exceeding 100 μm.

10. The process for producing an organic porous material according to claim 1, wherein a second pore with a smaller pore diameter than that of the first pore is formed at a surface of the skeleton.

11. The process for producing an organic porous material according to claim 10, wherein the average pore diameter of the second pore is in a range of 2 nm to 100 nm.

12. The process for producing an organic porous material according to claim 1, further comprising removing the organic polymer that remains in the organic porous material.

13. The process for producing an organic porous material according to claim 1, wherein the organic porous material is a separation medium for a liquid chromatography column.

14. An organic porous column, comprising a housing and an organic porous material obtained by a process according to claim 1, with the organic porous material being contained in the housing.

15. An organic porous material, comprising a co-continuous structure formed of a skeleton and a first pore, the organic porous material being obtained by:
subjecting a low molecular compound having living radical polymerizability and/or anionic polymerizability to living radical polymerization or anionic polymerization in a system including the low molecular compound, an organic polymer to be used as a phase separation inducing component, a polymerization initiator, and a polymerization solvent, and thereby forming a gel that includes a skeletal phase rich in a polymer of the low molecular compound and a solvent phase rich in the polymerization solvent and that has a co-continuous structure formed of the skeletal phase and the solvent phase, and
removing the polymerization solvent from the gel thus formed and thereby forming a skeleton containing the polymer as a base material thereof, from the skeletal phase while forming a first pore from the solvent phase.

16. The organic porous material according to claim 15, wherein an average pore diameter of the first pore is in a range of exceeding 100 nm but not exceeding 100 μm.

17. The organic porous material according to claim 15, wherein a second pore whose pore diameter is smaller than that of the first pore is formed at a surface of the skeleton.

18. The organic porous material according to claim 17, wherein the second pore has an average pore diameter in a range of 2 nm to 100 nm.
